(19) United States
(12) Patent Application Publication
(10) Pub. No.: US 2023/0390693 A1
(43) Pub. Date: Dec. 7, 2023

(54) ADSORPTIVE GAS SEPARATION PROCESS AND SYSTEM USING THIRD COMPONENT ADSORPTION TO DRIVE DESORPTION OF PURIFIED FIRST COMPONENT IN RAPID CYCLING GAS SEPARATION DEVICES

(71) Applicant: Svante Inc., Burnaby (CA)

(72) Inventors: Joel CIZERON, Burnaby (CA); Andrew LUI, Burnaby (CA); Omid GHAFFARI-NIK, Burnaby (CA); Sabereh REZAEI, Burnaby (CA); Anne FREEMAN, Burnaby (CA); Chujie ZHU, Burnaby (CA); Jahan AHMADI, Burnaby (CA); Nigel WHEELER, Burnaby (CA); Onder TULPAR, Burnaby (CA); Pierre HOVINGTON, Burnaby (CA)

(21) Appl. No.: 18/034,522

(22) PCT Filed: May 11, 2022
(86) PCT No.: PCT/IB2022/054398

§ 371 Date: Apr. 28, 2023

Related U.S. Application Data
(60) Provisional application No. 63/187,174, filed on May 11, 2021.

(51) Int. Cl. B01D 53/047; B01D 53/06

(52) U.S. Cl. CPC B01D 53/0476; B01D 53/06; B01D 2257/504; B01D 2258/0283; B01D 2256/10; B01D 2253/204; B01D 2253/108; B01D 2253/102; B01D 2253/25; B01D 2259/40086; B01D 2259/403; B01D 2253/202

(57) ABSTRACT

Generally, a cyclic sorptive gas separation process can comprise a feed or sorbing step followed by a regenerating step. In embodiments, the sorbing step can involve admitting said feed stream into a contactor, sorbing at least a portion of a first component onto a sorbent, producing a first product stream, and recovering a first product stream. In embodiments, the regenerating step can comprise admitting or feeding the first regeneration stream into the contactor, sorbing a fraction of a third component onto the contactor, desorbing a fraction of the first component, and recovering a second product stream from the contactor, wherein the regeneration step further comprises controlling a partial pressure of the third component to a partial pressure threshold equal to or greater than 0.4 Bara.

### FIELD

The present invention relates generally to processes for adsorptive gas separation of a multi-component fluid mixture and systems, and more specifically, processes enabling rapid injection and withdrawal of thermal energy during regeneration and conditioning of a gas separator.

### BACKGROUND

Adsorptive gas separation processes and systems, for example, temperature swing adsorption, pressure swing adsorption, vacuum swing adsorption and partial pressure swing adsorption, are known in the art for use in adsorptive gas separation of multi-component fluid mixtures.

One type of industrial process where gas separation can be desirable includes combustion processes, for example, where an oxidant and a carbon-containing fuel are combusted generating at least heat and a combustion gas stream (also known as a combustion flue gas stream). The separation of at least one target component from the combustion gas stream can be desirable, including for example, post-combustion gas separation of carbon dioxide, but offer several challenges including, for example, but not limited to that the volume of gas to be treated for separation can be large, the combustion gas stream can contain dilute amounts of the target component desired to be separated, and/or the combustion gas stream can be supplied at a low pressure.

A conventional temperature swing adsorptive gas separation process can typically employ two fundamental steps, an adsorption step and a regeneration step. During a typical adsorption step, a feed stream such as a multi-component fluid mixture can be admitted into an adsorptive separation system and a contactor comprising an adsorbent material, where the adsorbent material can adsorb a component of the feed stream, separating the adsorbed component from the remaining components of the feed stream. During a typical subsequent regeneration step, a fluid stream, for example, a heated fluid stream, can be admitted into the adsorptive separation system and contactor to increase the temperature of the adsorbent material, causing at least a portion of the adsorbed components to release from the adsorbent material, and allow for cyclic reuse of the adsorbent material. In some conventional systems and methods, a cooling or conditioning step can be employed to decrease the temperature of the adsorbent material after the regeneration step, to assist in restoring the adsorptive capacity of the adsorbent material prior to a subsequent adsorption step. A coolant or condition stream, for example, an air stream at near ambient temperatures, can be admitted into the adsorptive separation system and contactor to decrease the temperature of the adsorbent material. The adsorption, regeneration and conditioning steps can then be sequentially repeated.

In conventional adsorptive gas separation processes and systems, energy consumed for regeneration of adsorbent material can typically represent a large portion of the operating cost of such systems and processes, and such costs can typically act as barriers to wide adaptation and implementation of conventional adsorptive gas separation technology.

Additionally, the amount of sorbent desired to carry out the separation is inversely proportional to the cycle duration, for example, a process having a short cycle duration requires a smaller quantity of sorbent material relative to a process having a long cycle duration. Therefore, the ability to carry out rapid adsorptive process cycles has a large impact on the process economic viability.

The process and system described in this disclosure differs significantly from a vacuum swing system where sometimes steam is added as a stripping gas.

Other adsorptive gas separation processes, for example, capturing CO2 from ambient air, uses moisture swing which can be primarily driven by change in sorbent adsorption capacity for CO2 between the dried and wetted state without significantly changing the temperature of the adsorbent and typically does not produce a high purity product gas.

Conventional adsorptive gas separation processes and systems employing steam as an exemplary regeneration stream to cause desorption of one or more components from an adsorbent material can undesirably consume and reduce the quantity of steam high in energy which can be utilized for other processes in an industrial application, resulting in a reduction in the overall efficiency and increasing the operating cost of an integrated adsorptive gas separation process and system.

Furthermore, when employing steam as an exemplary regeneration stream to cause desorption of one or more components from an adsorbent material, steam can undesirably condense and adsorb on the adsorbent material, which can undesirably reduce the adsorbent adsorption and desorption kinetics by plugging pores resulting in a reduced cycle capacity of the adsorbent material, increase the time required to regenerate the adsorbent material, and/or increase the energy consumption for removal of the condensed steam leading to increasing the operating cost and/or reduced yield of an adsorptive gas separation process and system.

### SUMMARY

In embodiments, a cyclic sorptive gas separation process for separating a component of a feed stream comprising at least a first component, and a second component comprises a feed or sorbing step and a regenerating step. The feed or sorbing step can comprise steps involving admitting said feed stream into a contactor having at least a first sorbent therein, for contacting said feed stream with said first sorbent, sorbing at least a portion of said first component onto said at least first sorbent, producing a first product stream, at least partially depleted of said first component relative to said feed stream, and recovering said first product stream from said at least one contactor. In embodiments, the regenerating step comprises admitting or feeding at least a first regeneration stream having a third component into said at least one contactor, sorbing or condensing a fraction of said third component into said at least one contactor, desorbing a fraction of the at least first component sorbed onto said at least first sorbent, and recovering a second product stream from said at least one contactor. In embodiments, the regeneration step further comprises controlling a partial pressure of said third component in a first regeneration stream to a partial pressure threshold equal to or greater than 0.4 Bara for at least a of fraction of said regenerating step, wherein said at least one sorbent is one of: a metal organic framework (MOF) sorbent, a polyethylenimine doped silica (PEIDS) sorbent, an amine containing porous network polymer sorbent, an amine doped porous material sorbent, an amine doped MOF sorbent, a zeolite sorbent, an activated carbon, a doped activated carbon, a doped graphene, an alkali-doped or a rare earth doped porous inorganic sorbent.

In another broad aspect, a cyclic sorptive gas separation process for separating a component of a feed stream comprising at least a first component and a second component comprises contacting said feed stream along at least one contactor comprising at least one sorbent, sorbing said first component of said feed stream onto said at least one sorbent, producing a first product stream partially depleted of said first component relative to said feed stream, recovering said first product stream from said at least one contactor, producing a first regeneration stream having a third component within a vessel fluidly connected to said at least one contactor or within said at least one contactor, said first regeneration stream having partial pressure of said third component equal to or greater than a third component partial pressure threshold of 0.4 Bara, contacting said first regeneration stream with said at least one sorbent in said least one contactor, sorbing a fraction of said third component of said first regeneration stream onto said at least one sorbent and desorbing a fraction of said first component from said at least one sorbent, and recovering a second product stream from said at least one contactor.

In another broad aspect, a cyclic sorptive gas separation process for separating a component of a feed stream comprising at least a first component and a second component comprises a first feed or sorbing step, a second feed or sorbing step, a first regenerating step, a second regenerating step, a first conditioning step, and a second conditioning step.

In embodiments, the first feed or sorbing step comprises passing a first feed stream along at least one contactor comprising at least one sorbent, sorbing said first component of said first feed stream onto said at least one sorbent, producing a first fraction of first product stream partially depleted of said first component relative to said feed stream, and recovering said first fraction of first product stream from said at least one contactor.

In embodiments, the second feed or sorbing step comprises passing a second feed stream along said at least one contactor comprising said at least one sorbent, sorbing said first component of said second feed stream onto said at least one sorbent, producing a second fraction of first product stream partially depleted of first component relative to said second feed stream, and recovering second fraction of first product stream from said at least one contactor.

In embodiments, the first regenerating step comprises contacting a first regeneration stream having at least said third component with said at least one contactor comprising said at least one sorbent, sorbing a fraction of said third component from said first regeneration stream onto said at least one sorbent and desorbing said first component, and recovering a first fraction of second product stream from said at least one contactor.

In embodiments, the second regenerating step comprises controlling a partial pressure of said third component of a second regeneration stream to a third component partial pressure threshold of equal to or greater than 0.4 Bara, contacting said second regeneration stream with said at least one contactor comprising said at least one sorbent, sorbing a fraction of said third component from said second regeneration stream onto said at least one sorbent and desorbing said first component, and recovering a second fraction of second product stream from said at least one contactor.

In embodiments, the first conditioning step comprises at least one of reducing a partial pressure of said third component or a relative humidity of a gas phase contained in said at least one contactor and recovering a first fraction of third product stream from said at least one contactor, reducing a pressure of a gas phase contained in said at least one contactor and recovering a first fraction of third product stream from said at least one contactor, and admitting a first condition stream into said at least one contactor, said first condition stream having said third component and a third component partial pressure of equal to or less than a third component partial pressure threshold of 50% of an equilibrium vapor pressure of said third component at a temperature of said at least one sorbent at the end of step (b), flushing or sweeping said at least one contactor and recovering a first fraction of third product stream from said at least one contactor.

In embodiments, the second conditioning step comprises reducing a partial pressure of said third component or a relative humidity of a gas phase contained in said at least one contactor and recovering a second fraction of third product stream from said at least one contactor, reducing a pressure of a gas phase contained in said at least one contactor and recovering a second fraction of third product stream from said at least one contactor, and admitting a second condition stream into said at least one contactor, said second condition stream having said third component and a third component partial pressure threshold of equal to or less than a third component partial pressure threshold of 50% of an equilibrium vapor pressure of said third component at a temperature of said at least one sorbent at the end of step (b), flushing or sweeping said at least one contactor and recovering a second fraction of third product stream from said at least one contactor.

In embodiments, the said at least one sorbent can be one of: a metal organic framework (MOF) sorbent, a polyethylenimine doped silica (PEIDS) sorbent, an amine containing porous network polymer sorbent, an amine doped porous material sorbent, an amine doped MOF sorbent, a zeolite sorbent, an activated carbon, a doped activated carbon, a doped graphene, an alkali-doped or rare earth doped porous inorganic sorbent, and wherein during step (a1) and step (a2), or step (b1) and step (b2), or step (c1) and step (c2) are conducted having at least one of different pressures, different temperatures or with different process stream compositions between each step.

### BRIEF DESCRIPTION OF THE DRAWINGS

FIG. 1 is a schematic diagram illustrating an embodiment of the invention illustrating a sorptive separation system having stationary contactors, a feed stream conduit, a first product stream conduit, a condition stream conduit, a third product stream conduit, a first regeneration stream conduit, a second product stream conduit, and valves between the conduits and contactors;

FIG. 2 is a schematic diagram illustrating an embodiment of the invention illustrating a sorptive separation system having stationary contactors, a feed stream conduit, a first product stream conduits, a first regeneration stream conduit, a second product stream conduit, a first product recycle conduit, and valves between the conduits and contactors;

FIG. 3A is a graphical illustration of a temperature plot as a function of axial position having temperature on the Y-axis, and an axial position of a 1 meter contactor on the X-axis;

FIG. 3B is a graphical illustration of a plot showing an amount of a third or water component sorbed onto the contactor of FIG. 3A as a function of axial position, and a plot showing an amount of a first or carbon dioxide component sorbed as a function of axial position;

FIG. 4 is a schematic representation of an embodiment of the invention having a rotary adsorption machine (RAM) where a contactor 500 is configured to rotate around an axis through four stationary zones or segments A1, A2, A3 and B;

FIG. 5 is a schematic representation of an embodiment of the invention having two-stages configured with rotary adsorption machines (RAMs) having a second stage RAM;

FIG. 6 is a schematic representation of an embodiment of the invention having two-stages configured with rotary adsorption machines (RAMs), a first stage or first RAM fluidly connected to recover an effluent stream and admit the effluent stream as a feed stream to a second stage or a second RAM;

FIG. 7 is a schematic representation of an embodiment having a single stage rotary adsorption machine (RAM) or a RAM employing two sorbing steps, two regenerating steps and a conditioning step, where a first fraction of second product stream is recycled back to a second sorbing step;

FIG. 8 is a schematic representation of an embodiment having a single stage rotary adsorption machine (RAM) or a RAM having an additional conditioning step;

FIG. 9 is a graphical illustration of a first or carbon dioxide component concentration plot of a typical concentration profile of a gas stream, such as a second product stream, exiting a contactor during a regenerating step using steam as a regeneration stream over time, the concentration shown along the Y-axis and time shown on the X-axis;

FIG. 10 is a schematic representation of an embodiment of the invention illustrating steam recovery and upgrading integration with a vacuum conditioning step using an ejector, a heated water pump, and a water heater/heat exchanger;

FIG. 11 is a schematic representation of an embodiment of the invention illustrating a steam recovery system to upgrade steam recovered at low pressure during a vacuum drying step of a separation cycle, the system having an ejector, heated water pump and a water heater/heat exchanger;

FIG. 12a is a process flow diagram of an embodiment of the invention where the feed step and regenerating steps are split in three sub-steps, switching between single pass to in series operation for adjacent sorbent contactor;

FIG. 12b is a graphical representation illustrating an example of the implementation of the three regenerating sub-steps B1, B2, and B3, on a moving bed or contactor system; and

FIG. 13 is a process flow diagram of an embodiment of the invention where a part of the sorbent is immersed in a liquid containing the third component in association with a reduction of pressure.

### DESCRIPTION

For the purpose of this application, the following terms are defined as follows:

Active layer or solid layer: a thin configuration of porous material or active layer or sheet of porous material or composite laminate containing a porous material with a chemical affinity for a specific molecule or atom or ion which can be use in place of an adsorbent layer, a heterogeneous catalyst layer, or a combination of an adsorption and heterogeneous catalysis function layer.

Sheet or laminate: an active layer with a thickness of less than 1 mm which can be used for an adsorbent sheet, a heterogeneous catalyst sheet, or a combination adsorption and heterogeneous function sheet.

Active stack or stack: a grouping of active layers separated by spacers on at least a section of the layers which can be used in place of adsorbent stack or heterogeneous catalysis stack or a combination of adsorption and heterogeneous catalysis function stack. Active layers can touch and/or connect to each other.

Active contactor or contactor: an active stack or a group of active stacks for flowing a fluid to contact the active layers.

Active module or module: an active contactor or contactor after packaging restricting flow of process fluids in a direction other than from inlet to outlet, enabling installation of connector or mounting features for integration into a reactor or adsorption vessel and in some case providing mechanical support and pressure bearing envelop for the contactor.

Spacer: a millimeter scale discreet solid placed between active layers, sheets or laminates to provide mechanical support to the stack or contactor.

Heat capacity: a ratio of an amount of energy required to raise a temperature of a component by an amount to a temperature change before and after application of the energy.

Channel height: a smallest distance between active layers wetted surface in the direction perpendicular to the active layers.

Channel length: a distance between inlet edge and outlet edge of a channel substantially in an intended direction of flow of a fluid stream within the channel.

Channel width: the distance between flow barriers in a direction perpendicular to the intended direction of flow of a fluid stream within the channel and co-planar with the active layer.

Permeability: Ratio of dynamic viscosity by fluid velocity and pressure head loss per unit length.

$$β = \frac{μ QL}{A Δ p}$$

Laminar flow: a condition of flow of a fluid stream where fluid particles are mostly following smooth paths in layers with no eddies.

Inlet: structured contactor inlet or stack inlet face or immediate vicinity to a face from which a process fluid is admitted or enters when in use.

Outlet: structured contactor outlet or stack outlet face or immediate vicinity to a face from which a process fluid is recovered or exist when in use.

Sides: structured contactor side or stack faces or immediate vicinity to a face where there is no flow entering or exiting the face.

Middle: any area of the structured contactor or stack that is not in the immediate vicinity to the Inlet, Outlet of Sides.

Wetted surface: a surface of an active layer, a sheet, or a laminate, in contact with the flow channel, or a surface envelop of the sorbent exposed to open flow channels and excluding surface area within the dense phase containing the solid sorbent and pores in between primary sorbent particle.

Area: a contiguous area with at least 10% of the total area of the active layer.

The terms “sorbent”, “adsorbent” and “absorbent” can be used interchangeably herein.

The terms “sorptive”, “adsorptive”, and “absorptive” can be used interchangeably herein.

MOF: Metal organic framework, a crystalline structure composed of organic linkers and metal ion or small inorganic cluster.

PEI DS: Polyethylenimine (also referred to as “PEI”) doped silica, composite material where PEI or functionalized PEI is dispersed into a high pore volume silica enabling enhanced transport between PEI and a gas.

PNP: Porous network polymer, functionalized polymer having a high pore volume that is highly interconnect to promote exchange between a gas and sorption sites.

Flux of component: Rate of flow of a component in moles per second in or out of a defined volume, for example a contactor or a segment of a contractor.

Process selectivity: ratio of product adsorbed or recovered from the feed stream.

Dynamic selectivity: Observed selectivity of a process including the effect of transients and gradient in temperature and composition through a contactor. Dynamic selectivity differs from equilibrium selectivity observed when these gradients are not present and the sorbent loading matches the equilibrium adsorption values.

Time fractionation: Splitting of a process gas feed or effluent based on timing or phase of the process. For example, recovering a product or effluent from a first period of time then recovering the product from a second period of time. Differs from continuously splitting a stream regardless of phase of the process or elapsed time of a step of a process.

RAM: Rotary adsorption machine where two or more contactors are assembled onto a frame which can rotate around an axis, allowing for switching of fluid streams admitted into and recovered from the two or more contactors.

CO₂: Carbon dioxide molecule in any physical phase.

H₂O: Water molecule in liquid or condensed, gas, adsorbed or solid phase.

Heat of desorption: Amount of heat and/or energy consumed by reversing the adsorption process and returning the adsorbate to the gas phase or carrier liquid. Typically the negative value of the heat of adsorption.

Desired heat of desorption: Integral value of heat and/or energy consumed by reversing the adsorption process for a given amount of adsorbate. It is the minimal amount of energy that is desired to be supplied during a desorption step.

Bara: Bar absolute, unit of measure of pressure.

Feed stream: a multi-component gas stream containing a first component and a second component, which is admitted into a sorptive gas separator during a sorbing step. The first component is a target component for sorption during the sorbing step, separation, and recovery.

Regeneration stream: a gas stream containing a third component used to promote desorption of a first component adsorbed on a sorbent.

Condition stream: a gas stream used to promote desorption of the third component adsorbed on a sorbent.

### EMBODIMENTS

A sorptive gas separation process (herein referred to as a “sorptive process”) is provided in accordance with an embodiment of the present disclosure, for the sorptive gas separation of a multi-component fluid mixture or stream, such as combustion gas streams or flue gas streams. In embodiments, the multi-component fluid mixture can comprise at least a first component (which can comprise for example, carbon dioxide, sulfur oxides, nitrogen, nitrogen oxides, oxygen, and/or heavy metals) and a second component.

Embodiments of the sorptive process can be suitable for gas separation applications where one or more of the following conditions exist: a feed stream is sourced at a low pressure, for example, less than 2 Bara, making a pressure swing adsorption process less desirable; the feed stream comprises a low or dilute concentration of the target component, such as for example, where the target or first component comprises about 3 to 25 volume % of the feed stream; the volume of the feed stream to be separated is large; recovery of a product stream high in purity is desired, for example, about greater than 80 volume % purity of the target component is desired; low energy and/or steam consumption in the sorption process is desired; and/or low operating cost and installation cost are desired.

In one aspect, exemplary gas separation applications can include, for example, post-combustion gas separation of carbon dioxide from a combustion gas stream of a combined cycle power plant.

Typically, a multi-component fluid mixture employed as a feed stream for an adsorptive process can have a plurality of components where each component can have a different affinity for an adsorbent material in an adsorptive system. For example, in an exemplary post-combustion adsorptive gas separation application according to an aspect of the disclosure, a combustion gas stream can comprise at least a first component, for example, carbon dioxide (herein referred to as “CO₂”) having a weak (relative to other components in the combustion gas stream) affinity for an adsorbent material, a second component, for example, nitrogen (herein referred as “N₂”) having a very weak (relative to other components in the combustion gas stream) affinity, and a third component, for example, water (herein referred as “H₂O”) having a strong (relative to other components in the combustion gas stream) affinity for the adsorbent material.

A solid sorbent material used can employ physisorption and/or chemisorption adsorptive mechanisms and contain metal or metal oxide sorption sites distributed in a porous solid, for example, a metal organic framework material of MOF, or distributed on a porous carbon support or contains amine groups or nitrogen groups distributed in porous solids or impregnated porous solid containing liquid droplets with dissolved amine, for example, polyethylenimine supported in a porous support like porous silica (also known as polyethylenimine doped silica or PEI DS) or co-polymerized amine group with multifunctional ligands forming porous network polymers.

In various embodiments according to the present disclosure, a sorptive gas separation process for separating at least a first component from a multi-component fluid mixture is provided.

In an embodiment, a cyclic sorptive gas separation process comprises the steps of: during a sorbing or feeding step, admitting a multi-component fluid mixture as a feed stream into at least one contactor having at least one sorbent material, sorbing at least a portion of a first component of the feed stream on the at least one sorbent material in the at least one contactor, and recovering a first product stream. In embodiments, the first product stream can comprise at least a second component, which is, at least periodically depleted by greater than about 50% relative to the flux of the first component in the feed stream entering the contactor (first product stream at least periodically comprise less than about 50% flux of the first component relative to the flux of the first component in the feed stream); during a first regenerating step, admitting a first regeneration stream having at least a third component into the at least one contactor, and controlling a partial pressure of the third component; sorbing at least a portion of the third component on the at least one sorbent material in a quantity sufficient to generate heat. In embodiments, sufficient sorption of the third component can generate heat that is greater than about 2 times, or preferably greater than about 1.5 times the amount of heat desired for the heat of desorption required for the first component desorbed during the first regenerating step. In embodiments, the process further comprises recovering a second product stream which is at least periodically enriched in the first component relative to the feed stream. In embodiments, the second product stream contains greater than about 60% by volume of the first component, preferably greater than about 85% of the first component, post condensation of condensable components in the second product stream. In embodiments, the process further comprises, during a conditioning step, admitting a condition stream in the at least one contactor, desorbing a portion of the third component and a portion of the first component sorbed on the at least one sorbent material in the at least one contactor by at least one of a partial pressure swing or a pressure swing, and recovering a third product stream from the at least one contactor.

In a further embodiment, the at least one contactor used in the process can contain a structured sorbent with a wetted surface area to volume ratio of greater than about 1000 m²/m³, preferably greater than about 2000 m²/m³.

In a further embodiment, the process can be completed or carried out in equal to or less than about 2 minutes, preferably equal to or less than about 1 minute with a regenerating step of equal to or less than about 15 seconds or preferably equal to or less than about 10 seconds.

In a further embodiment, a pressure drop across the at least one contactor, resulting from flowing the feed gas at about 1 meter per second (herein referred to as “m/s”), is equal to or less than about 10 kPa, preferable equal to or less than about 5 kPa.

In a further embodiment, during a regenerating step, the sorbent can reach a temperature in a range between about 90° C. and about 150° C. The sorbent temperature during a regeneration step can be controlled by the selection of the sorbent structure formulation and heat capacity as well as the partial pressure of the third component in contact with the sorbent.

In a further embodiment, the process can further comprise a condition step, during which, a temperature of the sorbent is reduced from a temperature of the sorbent during the regenerating step by greater than about 20° C., preferably greater than about 40° C. by desorbing or removing the third component sorbed or stored in the sorbent. This can be achieve through an application of a vacuum or stripping the third component with a gas with a low concentration of the third component relative to the saturation pressure of the third component in the contactor.

In a further embodiment, during the first regenerating step, a molar ratio of the third component admitted into the at least one contactor to the first component recovered from the at least one contactor is less than about 6, preferably less than about 4, or most preferably less than about 3.

In an embodiment of the invention, the sorptive gas separation system for separating at least a first component from a multi-component fluid mixture comprises at least one contactor having a first end and an axially opposing second end, and can further comprise at least one sorbent material. In one such embodiment, the sorptive gas separation system is fluidly connected to admit at least a portion of the multi-component fluid mixture as a feed stream into the first end, to sorb at least a portion of the first component on the at least one sorbent material, which is fluidly connected to recover a first product stream from the second end thereof. The sorptive gas separation system can also be fluidly connected to admit a first regeneration stream into an end, for example, either the second end or the first end, to desorb at least a portion of the first component sorbed on the at least one sorbent material, for producing a second product stream. In embodiments, the system is also fluidly connected to recover a second product stream from an opposing end relative to the end which the first regeneration stream was admitted of the at least one contactor.

The sorptive gas separation system can also be fluidly connected to admit the multi-component fluid mixture as a condition stream in an end, for example, the second end or the first end, to desorb at least a portion of the first component sorbed on the at least one sorbent material, and fluidly connected to recover a third product stream from an opposing end relative to the end which the condition stream was admitted. In embodiments, a vacuum source from a pump, an ejector, or a heated piston, can be fluidly connected to an end or both ends of the contactor to remove or assist in removing the third component through a partial pressure swing and a pressure swing.

In an embodiment, a gas separation process can comprise the steps of: during a sorbing step, admitting a multi-component fluid mixture as a feed stream into at least one contactor comprising at least one sorbent material, sorbing at least a portion of the first component of the feed stream on the at least one sorbent material in the at least one contactor, and recovering a first product stream. In embodiments, the first product stream can comprise at least a second component, and is a least periodically depleted in the first component by greater than about 50% relative to the flux of the first component in the feed stream entering the contactor (first product stream at least periodically comprise less than about 50% flux of the first component relative to the flux of the first component in the feed stream); during a first regenerating step, admitting a first regeneration stream comprising at least a third component into the at least one contactor, and controlling a partial pressure of the third component; sorbing at least a portion of the third component of the first regeneration stream on the at least one sorbent material in a quantity sufficient to generate heat. In embodiments, sufficient sorption of the third component can generate heat greater than about 2 times, or preferably greater than about 1.5 times an amount of heat desired for the heat of desorption required for the first component desorbed in the first regenerating step. In embodiments, the process further comprises recovering a second product stream which is at least periodically enriched in the first component relative to the feed stream. In embodiments, the second product stream contains greater than about 85 volume % of the first component, preferably greater than about 90 volume % of the first component, post condensation of condensable components, for example, the third component, in the second product stream. In embodiments, the process further comprises, during a conditioning step, desorbing a portion of the third component and a portion of the first component sorbed on the at least one sorbent material by a pressure swing process or a vacuum swing process, and recovering a third product stream from the at least one contactor, and admitting the third product stream into a condenser for condensing at least a portion of the third component, and causing the pressure in the at least one contactor to drop for assisting the desorption of the third component. The non-condensing fraction of the third product stream can contain a high concentration of the first component, for example, greater than about 85 volume %, or preferably greater than about 90 volume %, and can be collected and combined with the second product stream, post compression, at the outlet of the vacuum pump.

In an embodiment, if a vacuum swing process is used during a conditioning step both the first and third components can be recovered simultaneously while cooling the contactor. In this case, the conditioning effluent or third product stream can be directed to a condensing unit to further purify or separate the third component from the first component, where the first component recovered during the conditioning step can then be combined post compression with the second product stream or first component recovered during the first regenerating step.

In a further embodiment, the first component is CO₂, the multi-component feed is a process flue gas from combustion of a fuel containing carbon, the second component is nitrogen, and the third component is water.

In further embodiments according to the present disclosure, a sorptive gas separation process for separating at least a portion of a multi-component fluid mixture into one or more components is provided.

In an embodiment, a process is provided, comprising the steps of: during a sorbing step, admitting a multi-component fluid mixture as a feed stream into at least one contactor having at least one sorbent material, sorbing at least a portion of a first component of the feed stream on the at least one sorbent material, and recovering a first product stream. In embodiments, the first product stream can comprise at least a second component, and can be at least periodically depleted in the first component by greater than about 50% relative to the flux of the first component in the feed stream entering the contactor (first product stream at least periodically comprise less than about 50% flux of the first component relative to the flux of the first component in the feed stream); during a first regenerating step, admitting a first regeneration stream comprising at least a third component into the at least one contactor and controlling a partial pressure of the third component, sorbing at least a portion of the third component of the first regeneration stream on the at least one sorbent material in the at least one contactor in a quantity sufficient to generate heat. In embodiments, sufficient sorption of the third component can generate hear that is greater than about 2 times, or preferably greater than about 1.5 times an amount of heat desired for the heat of desorption required for desorption of the first component from the at least one sorbent material. In embodiments, the process further comprises recovering a second product stream which is at least periodically enriched in the first component relative to the feed stream. In embodiments, the second product stream contains greater than about 85 volume %, or preferably greater than about 90 volume % of the first component, post condensation of condensable components in the second product stream. In embodiments, the process further comprises admitting the second product stream into a condenser, condensing at least a portion of the third component from the second product stream, forming a condensate stream and a purified second product stream, where the purified second product stream is depleted in the third component relative to the second product stream; and during a conditioning step, admitting a condition stream in the at least one contactor, desorbing a portion of the third component and a portion of the first component sorbed on the at least one sorbent material in the at least one contactor by at least one of a partial pressure swing process or a pressure swing process, and recovering a third product stream from the at least one contactor; and admitting the third product stream into a condenser, condensing at least a portion of the third component from the third product stream, forming a first stage condensate stream and a first stage purified third product stream, where the first stage purified third product stream is depleted in the third component relative to the third product stream.

In an embodiment, a cyclic sorptive gas separation process comprises the steps of: during a sorbing or feeding step, admitting a multi-component fluid mixture as a feed stream into at least one contactor having at least one sorbent material, sorbing at least a portion of a first component of the feed stream on the at least one sorbent material in the at least one contactor, and recovering a first product stream. In embodiments, the first product stream can comprise at least a second component, which is, at least periodically depleted by greater than about 50% relative to the flux of the first component in the feed stream entering the contactor (first product stream at least partially comprise less than about 50% flux of the first component relative to the flux of the first component in the feed stream); during a first regenerating step, admitting a first regeneration stream having at least a third component into the at least one contactor, and controlling a partial pressure of the third component; sorbing at least a portion of the third component on the at least one sorbent material in a quantity sufficient to generate heat. In embodiments, sufficient sorption of the third component can generate heat that is greater than about 2 times, or preferably greater than about 1.5 times the amount of heat desired for the heat of desorption required for desorption of the first component during the first regenerating step. In embodiments, the process further comprises recovering a second product stream which is at least periodically enriched in the first component relative to the feed stream. In embodiments, the second product stream contains greater than about 60 volume % of the first component, preferably greater than about 85 volume % of the first component, post condensation of condensable components in the second product stream. In embodiments, the process further comprises, during a conditioning step, admitting a condition stream in the at least one contactor, desorbing a portion of the third component and a portion of the first component sorbed on the at least one sorbent material in the at least one contactor by at least one of a partial pressure swing or a pressure swing, and recovering a third product stream from the at least one contactor. In embodiments, the third product stream can be admitted into a condenser condensing at least a portion of the third component, causing the pressure in the at least one contactor to drop, assisting the desorption of the third component.

In a further embodiment the first component is CO₂, the multi-component feed is a process flue gas from combustion of a fuel containing carbon, the second component is nitrogen, and the third component is water.

In further embodiments according to the present disclosure, a sorptive gas separation process for separating at least a first component from a multi-component fluid mixture is provided.

In an embodiment according to the present disclosure, a sorptive system comprises one or more heat exchangers, at least one sorptive separator, at least a first condenser or a phase separator stage further comprising at least one or more of a first condenser, for example, a condensing heat exchanger, and in some embodiments, at least one fluid pump, for example, an ejector. In such embodiments, a sorptive separator can be stationary or moving, and can comprise at least one stationary or moving contactor for supporting at least one sorbent material.

The sorptive separator can further comprise an enclosure for housing the at least one contactor. In embodiments, the enclosure can also assist in defining a plurality of stationary or moving zones, for example, an sorption zone, a first regeneration zone, a second regeneration zone, and a conditioning zone, within the enclosure where each zone is substantially fluidly separated and a point on the at least one contactor can cycle through each zone.

In an embodiment, for example, a sorptive separator comprises at least one contactor which can move, cycle, and/or rotate around an axis through a plurality of stationary zones, or a sorptive separator comprises at least one contactor which is stationary and can have a plurality of zones which move, cycle and/or rotate around the at least one contactor. In one embodiment, an sorptive contactor comprises: a plurality of substantially parallel walls which can define a plurality of substantially parallel fluid flow passages, oriented along a longitudinal axis of the contactor, between a first end and a second end which are axially opposed; at least one sorbent material in and/or on the walls of the contactor, and optionally a plurality of axially continuous electrically and/or thermally conductive filaments oriented substantially along the longitudinal axis of the contactor which can be in direct contact with at least one sorbent material in and/or on the walls of the contactor.

In a further embodiment a plurality of contactors or machines can be combined and fluidly connected to form a system where the effluent or product stream of a contactor or a machine can be admitted as a feed stream of another contactor or machine. In particular, a first fraction of the first effluent or first product stream can be directed and admitted into another contactor or machine to improve recovery of a desired product, or a fraction of a pre-regeneration stream or a fraction of a pre-condition stream can be advantageously reused by recycling and admitting the fraction into another contactor with or without mixing into another stream advantageously.

In a particular embodiment a second fraction of a first product containing a higher concentration in a first component can be directed to a contactor or machine that has been regenerated and conditioned having the greatest sorption capacity for sorption of the first component during a sorptive process cycle.

In an embodiment a first fraction of a regeneration stream containing a mixture of a first component and a second component can be directed to and admitted into a contactor or machine during a sorbing step. This recycle or first fraction of the regeneration stream can comprise a concentration of the first component greater than a concentration of the first component in a feed stream.

In a particular embodiment a fraction of the effluent recovered from a contactor during a conditioning step, for example, a third product stream, or an effluent from a pre-conditioning step, can be recovered, directed to and combined with a pre-regenerating stream for admittance into a contactor during a pre-regenerating step. While combining the pre-regenerating stream with an effluent recovered during the pre-conditioning or conditioning step would somewhat dilute the third component admitted during the pre-regenerating step, the recycled third component contained in the pre-conditioning or conditioning effluent can contribute to pre-heating of or adding heat to the sorbent bed or contactor. During the pre-regenerating step, pressure of the combined pre-regeneration stream can be increased to improve sorption of the third component.

When applied to CO₂ capture from a flue gas stream where the third component is water or steam, recovery of water within the sorptive process can be economically beneficial. The two main sources of water which can be recovered from a sorptive process and system are during a sorbing step and a conditioning step. A relatively small amount of water can be recovered during the regenerating step of the sorptive process.

In an embodiment, a pre-conditioning step can be added after a first regenerating step and prior to a conditioning step, to desorb and recover the third component or water from a contactor during the pre-conditioning step where a concentration of water in an effluent stream recovered during the pre-conditioning step is high, for example, a concentration of water equal to or greater than about 30 volume %.

In one aspect, exemplary such contactors can comprise exemplary parallel passage adsorbent contactors which are disclosed in Applicant's U.S. Pat. No. 8,940,072.

In an aspect, the contactor can be stationary or moving within an enclosure. In a particular embodiment, the at least one sorbent material of a contactor can desirably be dynamically selective for sorption of a first component over at least one other component of a multi-component fluid mixture, such that a dynamic selectivity is sufficiently high to usably provide sorptive separation of the fluid mixture by selective sorption of the first component.

Such dynamic selectivity over the cycle of the sorptive process can comprise at least one of an equilibrium selectivity or saturation for the first or third component of at least one sorbent material segment along the direction of flow.

In a process embodiment according to the present disclosure, an initial step of a sorptive process or a feed stream cooling step for a feed stream can be employed to reduce the temperature of the feed stream prior to admitting the feed stream into a sorptive separator and at least one contactor. During the initial step or feed stream cooling step for a feed stream, a feed stream source, for example, a fuel combustor, can produce and admit a multi-component fluid mixture or feed stream into a sorptive system and an heat transfer device, such as for example, a gas-to-gas heat exchanger, a gas-to-liquid heat exchanger or a direct contact cooler (herein referred to as “DCC”), where heat from the feed stream can be transferred to a coolant stream, for example a water stream, admitted into and within the DCC, reducing the temperature of the feed stream to equal to or less than a first temperature threshold. In an embodiment, the temperature of the feed stream can be reduced to equal or less than a first temperature threshold of, for example, about 50° C., or in particular about 40° C., or more particularly about 30° C. The feed stream and coolant stream can then be recovered from the heat exchanger or DCC.

In an embodiment, during a sorbing step, the feed stream, can comprise a multi-component gas stream at a temperature equal to or less than a first temperature threshold and at a pressure greater than about an ambient pressure. In an embodiment, ambient pressure can comprise, for example, between about 70-105 kPa absolute (herein referred as “kPa_{abs}”), dependent upon factors such as but not limited to the location, elevation, conditions and temperature of the ambient environment at a particular location. In an embodiment, the feed stream can be admitted into the sorptive separator, a sorption zone of the sorptive separator, and at least one contactor or a portion of a contactor within the sorption zone, to enter a first end of the contactor to flow substantially in a direction towards a second end of the contactor. As the feed stream contacts the at least one sorbent material in a contactor or a portion of a contactor within the sorption zone, at least a portion of a first component of the feed stream, such as for example, CO₂ in an exemplary embodiment comprising a combustion gas feed stream can sorb on the at least one sorbent material, separating the first component from the remaining non-sorbed components of the feed stream.

In one such embodiment, the sorption process is exothermic where a heat of adsorption is released during sorption of a first component on the sorbent material. This forms a thermal wave that moves in a direction substantially the same as the direction of flow of the feed stream in the contactor, such as for example, in a direction from the first end towards the second end of the contactor. The majority of the heat generated can be stored in the contactor in the form of heat capacity of the contactor at a temperature above the feed stream temperature, unless a significant fraction of a third component is desorbed during the sorbing step. The remaining non-sorbed components of the feed stream, such as for example, the second component or N₂ in an exemplary embodiment comprising a combustion gas feed stream, substantially form a first product stream which is at least periodically depleted in the first component, for example, CO₂, relative to the feed stream, more specifically with at least 50% less flux of the first component in the first product stream than in the feed. The first product stream can be recovered from the second end of the contactor, sorption zone, sorptive separator and sorptive system. In an embodiment, the sorbing step can be completed and/or terminated when a pre-determined value has been achieved [for example, when a predetermined sorption time has elapsed, when a predetermined event has been achieved, and/or before or after breakthrough of the first component from a location at or near an end (for example, second end) of a contactor] or detection of a rapid temperature rise at a specific location of the sorbent contactor. The timing of the sorbing step and feed stream flow can also be tuned to optimize recovery of the first component and use of steam by continuously measuring for: a change in a concentration of the first component in the feed stream, a reduction in flux of the first component in a flue gas stream or a feed stream to a reduction in flux of the first component in a first product stream, or a change in ambient temperature and pressure.

Upon completion and/or termination of the sorbing step, a subsequent first regenerating step follows. The first regenerating step can be followed by a subsequent pre-conditioning step, for example, for the fractional removal of the second component remaining in the void space and dead volume of a contactor through evacuation of the contactor at low pressure and flushing with steam at low pressure, for example, lower than 0.2 Pa partial pressure, to avoid extensive sorption of steam on the sorbent material used in the contactor.

In an embodiment, splitting of a fraction of the first product stream, based on time fractionation, can be employed during the sorbing step where at least a portion of the first product stream (which can contain a significant fraction the first component or greater than 10% of the first component feed flux, preferably greater than 30% of the first component feed flux) can be recovered from the contactor, and admitted into at least one of another sorptive separator or a contactor as portion of the feed stream during a sorbing step, for example, fed as a blend with the feed stream, or admitting sequentially before or after admitting of the feed stream depending on the concentration of first component in the recovered first product stream fraction, which advantageously increase the recovery of the first component from the feed stream.

In an embodiment, the first product stream splitting step can be initiated when, for example, a breakthrough of the first component from the second end of a contactor has been achieved, prior to the breakthrough of the first component from the second end of a contactor, when a pre-determined temperature threshold at or near an end of a contactor has been reached, or when a pre-determined elapsed time threshold of a sorbing step has been reached.

In a further embodiment, the first product stream splitting step is completed and/or terminated, for example, when a predetermined time threshold of a sorbing step has been achieved, at or near initiation of a first regenerating step, or when a predetermined concentration of at least one of the first component or second component has been achieved in the first product stream.

In an aspect, a first regenerating step is employed to at least partially regenerate or desorb at least a portion of the first component sorbed on the at least one sorbent material of the contactor or a portion of the contactor within a first regeneration zone.

In embodiments, a first regenerating step is initiated, for example, upon completion of the sorbing step, termination of the sorbing step, or before a thermal wave formed during the sorbing step breaks through an end (which the feed stream flows towards, for example, the second end) of the contactor.

Alternatively, a first regenerating step can be initiated, at or before a time where less than about 5% of the first component captured in the sorbing step breaks through an end of the contactor, and/or when one or more pre-determined thresholds have been achieved, such as for example, thresholds in relation to elapsed time or a sorbing step, duration of a sorbing step, pressure differential across a contactor, a temperature of gas or solid within a section of the contactor is achieved, and/or when one or more pre-determined threshold concentrations or flow of a selected component, components or stream is achieved.

In an embodiment, a first regenerating step can employ a first regeneration stream desirably low in exergy, such as for example, a steam stream at low pressure, which can advantageously utilize energy and/or a low pressure steam stream which can otherwise be exhausted and/or not utilized in a particular process, or by an integrated sorptive gas separation system, thereby desirably reducing the consumption of a higher pressure steam stream or steam stream high in exergy. In an aspect, such utilization of a low exergy regeneration stream, can result in reducing an energy penalty or operating cost associated with the sorptive process. Towards the end of the regeneration step a first regeneration stream can be admitted having a partial pressure of the steam within a partial pressure range of about 0.5 to 1.2 Bara in order sorb or condense a desirable amount of water on or into the sorbent and/or contactor.

In an embodiment during a first period of the first regenerating step, a partial pressure of steam in the first regeneration stream is reduced to between about to about 0.2 Bara in order to drive some of the inert components such as nitrogen and oxygen from the dead volume in the contactor and the void space within the contactor prior to recovering the CO₂. During a second period of the first regenerating step, a partial pressure of steam in the first regeneration stream is by increased greater than about 0.5 Bara, which enables sorbing of the majority of the water in the first regeneration stream, which results in preferably releasing at least about 1.5 times an amount of heat of desorption for CO₂ required for sorption, condensation, and pore condensation.

In an embodiment, the regenerating step takes equal to or less than 15 seconds, preferably equal to or less than 10 seconds, more preferably equal to or less than 8 seconds, most preferably equal to or less than 5 seconds, to desorb at least 50% of the sorbed first component from the at least one sorbent material while consuming less than 6 moles of third component per mole of CO₂ recovered, preferably less than 4 moles of third component per mole of CO 2 recovered, most preferably less than 3 moles of third component per mole of CO₂ recovered.

During the first regenerating step, desorption of at least a portion of a first component sorbed on the at least one sorbent material can be driven primarily by at least one of: a partial pressure swing, for example, a difference in partial pressure or concentration of at least one component of the first regeneration stream and an equilibrium partial pressure of the at least one component sorbed on the at least one sorbent material and/or, a swing in heat of adsorption energy, for example, the difference in heat of adsorption energy of at least one component of the first regeneration stream and the at least one component sorbed on the at least one sorbent material, and/or a vacuum swing, for example, a swing in pressure during a feed or separating step and regenerating step, for example, a first regenerating step or a combination of these processes.

In a further embodiment, a first regeneration stream can comprise substantially a condensable fluid stream, and during a first regenerating step a plurality of first regeneration streams can be employed, for example, a (first) first regeneration stream comprising substantially a first component and a (second) first regeneration stream comprising substantially a third component, or a (first) first regeneration stream comprising a partial pressure of steam between about 0.05 to about 0.2 Bara and a (second) first regeneration stream comprising a partial pressure of steam greater than about 0.5 Bara.

For example, an initial injection of CO 2 at the beginning of a first regenerating step can be beneficial in increasing the purity of the recovered fraction of CO₂ in a second product stream or admitting a fraction of a second product stream with low purity can be recycled to a contactor just before the first regeneration step as the second product stream with low purity can pre-heat or add additional heat to the contactor and sorbent, resulting in increasing the recovery of CO₂.

In accordance with a particular process embodiment, in a first regenerating step, a first regeneration stream source (such as for example, a low pressure stage or a very low pressure stage of a multistage steam turbine, a very low pressure steam turbine, a heater or a heat exchanger), can supply and admit a first regeneration stream comprising low exergy, for example, water in the form of a steam stream at a pressure equal to or less than about 300 kPa_{abs}, or in particular, equal to or less than about 200 kPa_{abs}, or more particularly equal to or less than about 100 kPa_{abs}, into the sorptive system, a sorptive separator, an first regeneration zone, a contactor or a portion of the contactor in the first regeneration zone.

The pressure of the first regeneration stream or steam stream can also be reduced prior to entering the contactor by passing through a high pressure port of an ejector as a motive stream while recovering a lower pressure steam stream through a low pressure port of the ejector generated during a conditioning step. Since the amount of recovered sub-atmospheric pressure steam would be low, an additional steam compressing device can be added to loop or recycle steam around the ejector in order to collect more or increase the quantity of low pressure steam.

In one such aspect, as a first regeneration stream contacts the at least one sorbent material, the third component (such as for example, H₂O), having a strong affinity for the at least one sorbent material relative to the first component (such as for example, CO₂), can sorb on the at least one sorbent material, generating a heat of adsorption which can be employed in combination with the heat stored in the sorbent from the sorption of the first component during a sorbing step (which can also be referred to as the feed step or separating step) and to a lesser degree the heat contained in the first regeneration stream to desorb at least a portion of the first component sorbed on the at least one sorbent material on a contactor or a portion of the contactor in the first regeneration zone during the first regenerating step.

Employing at least a portion of the heat of adsorption, for example, sorption of the third component or H₂O, generated during the first regenerating step can advantageously: reduce the amount of energy, for example, heat energy and/or exergy, required or desired and employed in the first regeneration stream; enable the first regeneration stream to comprise a quantity of heat less than about a quantity of heat consumed for desorbing the at least one component (for example, the first component) sorbed on the at least one sorbent material in a contactor and recovered in a second product stream; enable the employment of a first regeneration stream low in exergy; and/or reduce the amount of first regeneration stream admitted during the first regenerating step (which can result in reducing the energy consumption and/or formation of condensation on the at least one sorbent material).

In an aspect, a portion of the first regeneration stream and/or first component, desorbed from the at least one sorbent material forms a second product stream which is enriched in the first component relative to the feed stream. The second product stream can be recovered from an end, for example, the first end of the contactor or the first end of a portion of the contactor in the first regeneration zone, first regeneration zone and sorptive separator.

In a particular embodiment, a first portion of the second product stream recovered from the contactor can be enriched in the first component relative to the feed stream or comprising substantially the first component, with a low ratio of partial pressure to saturation pressure of the third component (or a large concentration of the first component with a low relative humidity), while a second or subsequent portion of the second product stream recovered from the contactor or a portion of the contactor in the first regeneration zone, first regeneration zone, and sorptive separator can be highly enriched first component (for example, in a concentration range of about 60 volume % to 95 volume % in the first component) and enriched in the third component relative to the feed stream or comprising substantially the third component.

In a further embodiment, the first portion of the second product stream enriched in the first component, which can comprise substantially the first component, can be employed and admitted as at least a portion of a regeneration stream in a regenerating step, for example, a second regeneration stream in a second regenerating step. In one such aspect, the second portion of the second product stream enriched in the third component or comprising substantially the third component can be admitted into at least one condenser or condensing heat exchanger during a condensing step.

In an embodiment, a condensing step can be employed to condense and separate at least one condensable component from at least a portion of the second product stream and at least a portion of a third product stream recovered from a contactor and sorptive separator which can be admitted into a condenser or a condensing heat exchanger to form a second product condensate stream and a purified second product stream which can be higher in purity or have a greater concentration of the first component relative to a concentration of the first component in the second product stream recovered from the sorptive separator and contactor.

A pressure drop or a vacuum can also be induced during the condensing step in a condenser or a condensing heat exchanger, but need not be. In an embodiment, the condensing step is subsequent to the first regenerating step and can occur substantially simultaneously and substantially continuously with a regenerating step, for example, the first regenerating step, a second regenerating step, and/or a conditioning step.

A condensing step can comprise: admitting at least a portion of the second product stream or at least a portion of a third product stream recovered from a contactor and sorptive separator into a product circuit or a hot circuit of at least a first condenser, such as for example, a first condensing heat exchanger of at least a first condenser stage; admitting a coolant stream recovered from a coolant source into a coolant circuit or a cold circuit of the at least a first condenser (for example, first condensing heat exchanger, of the at least a first condenser stage), removing heat from the product circuit or hot circuit of at least a first condenser (for example, a first condensing heat exchanger of at least a first condenser stage) causing at least one component in at least a portion of the second product stream and at least a portion of a third product stream in product circuit or a hot circuit of at least a first condenser (for example, a first condensing heat exchanger of the at least first condenser stage) to condense and separate from the at least a portion of the second product stream and at least a portion of a third product stream, forming a purified second product stream and a condensate stream while inducing a reduced pressure and/or a vacuum, for example, equal or less than about 100 kPa_{abs}, or specifically equal or less than about 80 kPa_{abs}, or more specifically equal or less than about 50 kPa_{abs}, or most specifically, equal or less than about 20 kPa_{abs} in at least the hot circuit of at least a first condenser (for example, a first condensing heat exchanger) and at least a portion of the sorptive separator and at least a portion of a contactor; recovering the coolant stream from the coolant circuit or a cold circuit of the at least a first condenser (for example, first condensing heat exchanger, of the at least first condenser stage); recovering a purified second product stream and a condensate stream from the product circuit or hot circuit of at least a first condenser (for example, a first condensing heat exchanger of at least a first condenser stage).

The recovered liquid water from the hot circuit of the at least a first condenser can be recycled to the boiler to produce steam.

In an embodiment during a condensing step, at least a first condenser stage, comprising at least a first condenser, for example, a first condensing heat exchanger, having a cooling circuit or cold circuit and a product circuit or hot circuit which are fluidly separate, can be employed. In the condensing step, at least a portion of the second product stream or at least a portion of a third product stream, for example, at least a portion of a third product stream which can be enriched in the third component, recovered from at least one contactor, first regeneration zone of the sorptive separator, second regeneration zone of the sorptive separator, sorptive separator and can be admitted into a product or hot circuit of at least a first condensing heat exchanger of the at least first condensing stage. A coolant stream can be recovered from a condenser coolant source, admitted into the cooling or cold circuit of at least a first condensing heat exchanger of the at least first condensing stage to transfer and remove heat from the product circuit of the at least a first condensing heat exchanger of the at least first condensing stage, which can cause condensable components, for example, third component, in at least a portion of the second product stream or at least a portion of a third product stream in the product circuit to condense and separate, forming a condensate stream and a purified second product stream comprising the first component while optionally inducing a pressure drop and/or a vacuum, for example, equal or less than about 100 kPa_{abs}, or particularly equal or less than about 80 kPa_{abs}, or more particularly equal or less than about 50 kPa_{abs}, or even more particularly, equal or less than about 20 kPa_{abs}, within the product circuit and fluidly connected passages, including for example, fluidly connected portions of the sorptive separator, first regeneration zone of the sorptive separator, second regeneration zone of the sorptive separator, fluidly connected portions of the contactor, and passages upstream to the sorptive separator.

The coolant stream can be recovered from the cooling circuit of the at least a first condensing stage and at least a first condensing heat exchanger. The condensate stream can be recovered from the product or hot circuit of the at least first condensing heat exchanger and at least first condensing stage, with a pump. After at least partial condensation of, or separation of the condensable component from the at least a portion of second product stream and at least a portion of third product stream in the product circuit, the purified second product stream can form, and can be recovered from the product circuit of the at least first condensing heat exchanger and at least first condensing stage.

At least one pump including, for example, an ejector, a vacuum pump, or a single stage or multistage compressor operating at sub-ambient inlet pressure, and/or at least one valve, for example, a check valve or a throttling valve, can be fluidly connected downstream of the product recovery circuit or downstream of a condenser or condensing heat exchanger and/or a condensing stage to assist in at least one of recovering the purified second product stream from, maintaining a reduced pressure or vacuum in, and/or further reducing the pressure in, a condenser or condensing heat exchanger and/or a condensing stage.

In embodiments, at least one pump including, for example, an ejector, a vacuum pump, or a single stage or multistage compressor operating at sub-ambient inlet pressure, and/or at least one valve, for example, a check valve or a throttling valve, can be fluidly connected downstream to a condenser or condensing heat exchanger and/or a condensing stage to assist in at least one of recovering the third component from the conditioning step, maintaining a reduced pressure or vacuum in, and/or further reducing the pressure in, a condenser or condensing heat exchanger and/or a condensing stage, and/or reducing the pressure in, a sorbent contactor.

A purified second product stream recovered from the at least first condensing heat exchanger and/or at least first condensing stage, or pump, can be directed and admitted into an end use of the purified second product stream, via a compressor to increase the pressure of the purified second product stream to form a compressed second product stream. In one aspect, maintaining a reduction in pressure or vacuum in the product circuit of the at least first condensing heat exchanger and at least first condensing stage and fluidly connected portions of the sorptive separator, first regeneration zone, second regeneration zone, and at least a portion of a contactor can advantageously enable a vacuum desorption mechanism or vacuum assisted desorption of one or more components from the at least one sorbent material of the contactor or the at least one sorbent material of a portion of a contactor in an first regeneration zone and/or second regeneration zone, during a first regenerating step and/or a second regenerating step.

Furthermore, in an embodiment, the reduction in pressure or vacuum within the contactor can also advantageously reduce the quantity of first regeneration stream or third component desired or required for the first regenerating step, formation of condensation, and/or sorption of a condensable component in a condensed form, for example, third component or H₂O on the at least one sorbent material, which can further result in reducing the energy consumed for desorption of the sorbed components or regeneration of the at least one sorbent material and operating costs. The amount of sorbed third component in the first regenerating step is directly proportional to the amount of stored water on the sorbent prior to the first regenerating step and the equilibrium capacity of the third component partial pressure of the first regeneration gas stream at the temperature of the sorbent at the end of the regenerating step.

A partial pressure of a third component or a pressure of steam if undiluted is desirably adjusted and controlled in order to inject sufficient energy into the sorbent to raise the sorbent temperature and provide the heat of desorption of the first component.

In an alternative embodiment, employing at least a first condenser stage comprising at least a first condensing heat exchanger and at least one ejector, can advantageously induce a pressure reduction or a vacuum without employing a mechanically actuated vacuum pump, for example, an electric powered vacuum pump, which can result in reducing the energy consumption and operating cost during at least a first regenerating step and sorptive gas separation process.

In a further aspect, when the above described vacuum desorption mechanism is employed to assist in regeneration of the at least one sorbent material, for example, during a first regenerating step, a first regeneration stream can be admitted into a contactor at a suitably reduced pressure to facilitate vacuum assisted desorption of the first component from the sorbent material. Such pressure reduction of the first regeneration stream can be achieved by throttling, for example, over a valve, or by mechanical expansion to provide some energy recovery.

In an embodiment, heat of compression extracted at an aftercooler or intercooler downstream of a vacuum pump or a compressor, or between compressor stages of a multistage compressor, can be recovered and employed for the sorptive gas separation process, such as for example, to generate a low pressure steam stream. In such embodiments, a low pressure steam stream can be generated at a pressure equal to or less than about 300 kPa_{abs}, or particularly, equal to or less than about 200 kPa_{abs}, or more particularly equal to or less than about 100 kPa_{abs}, which can form at least a portion of the first regeneration stream and/or to replenish steam recovered from the low exergy regeneration stream source, first regeneration stream source or a steam turbine, or to increase the temperature of a fluid stream comprising substantially a third component to a suitable temperature for employment as a first and/or a second regeneration stream. In another aspect, further or additional condensation of third component from a purified second product stream can be achieved by employing additional condenser or condensing heat exchanger stages, and/or between at least the lower pressure stages of a multistage compressor employed for compression of a purified second product stream recovered from the condensing heat exchanger.

In an embodiment, during a condensing step, at least a first ejector can be employed to assist in at least one of recovering the purified second product stream from a condenser, maintaining a reduced pressure or vacuum in a condenser, and/or further reducing the pressure in a condenser and can be fluidly connected downstream of a condenser or a condensing heat exchanger and fluidly connected to a purified second product stream source, for example, a compressor, which can supply the purified second product stream at an elevated pressure. In one aspect, a purified second product stream can be recovered from a condenser or a condensing heat exchanger and admitted into a low pressure port of an ejector. In a further aspect, a purified second product stream at elevated pressure, for example, greater than about 150 kPa_{abs}, or particularly greater than about 200 kPa_{abs}, or more particularly greater than about 600 kPa_{abs}, (herein referred as “compressed second product stream”) can be recovered from a compressor or one or more lower pressure stages of a multistage compressor and admitted as a motive stream into a high pressure port of the ejector, which can desirably assist in recovering the purified first component in the second product stream from the contactor.

In an embodiment, a pre-regenerating step can be employed, after a sorbing step and prior to a first regenerating step, to increase the purity of the second product stream recovered from the contactor during the first regenerating step. During a pre-regenerating step, a pre-regeneration stream can be employed comprising at least a portion of a first regeneration stream, or a fluid stream comprising substantially the third component, for example, a first fraction of a condition stream, and can be recovered from a first regeneration stream source and admitted into the sorptive system, sorptive separator, and at least one contactor before injecting the first regeneration stream.

In one aspect, a pre-regeneration stream can desorb at least a portion of the second component or other diluent fluid components which can be undesirably co-sorbed on the at least one sorbent material, forming a reflux to feed stream which can comprise a larger concentration of the second component relative to other components in the reflux to feed stream and can be enriched in the first component relative to the feed stream. The reflux to feed stream can be recovered from the first end of the contactor, recycled and admitted into the contactor prior to a sorbing step or after the sorbing step.

In a particular process embodiment, a conditioning step subsequent to a first regenerating step, can be employed to at least partially regenerate the at least one sorbent material of the contactor, for example, to desorb at least partially the third component sorbed on the at least one sorbent material. During a conditioning step, desorption of a component sorbed on the at least one sorbent material can be driven primarily by a swing in temperature and/or swing in partial pressure or concentration of at least one component. As faster process steps and process cycles are beneficial to the process economics it is most advantageous to use a partial pressure swing of the third component to remove both the third component and cool the sorbent contactor during a conditioning step.

A condition stream can, comprise, at least one component having a partial pressure less than an equilibrium partial pressure of the at least one component sorbed on the at least one sorbent material in a contactor, and/or a fluid stream enriched in a second component relative to the feed stream, for example, a concentration greater than about 50% of the second component. According to one aspect, a condition stream can be at a temperature of equal to or greater than a second temperature threshold, such as for example, about a condensation temperature of the condition stream, and below a temperature of the at least one sorbent material during the first regenerating step. In one such aspect, suitable fluid streams for employment as a condition stream can include, for example, a combustion gas stream produced and recovered from a fuel combustor or an air stream at elevated temperatures, and/or a portion of a second product stream, for example, a first portion of a second product stream with a low partial pressure of the third component or low humidity.

In a particular process embodiment, in a conditioning step, a condition stream source, for example, a fuel combustor, can admit a condition stream into the sorptive system, sorptive separator, condition zone, and contactor or a portion of the contactor in the condition zone to enter the first end of the contactor to flow in a direction substantially towards the second end of the contactor, or in a co-current flow direction in relation to the direction of flow of the feed stream. As the condition stream flows in the contactor and contacts the at least one sorbent material, a swing in temperature and/or a difference in partial pressure or concentration between the condition stream and an equilibrium partial pressure of the sorbed components, such as for example, the third component and first component, can desirably cause at least a portion of the sorbed components to desorb from the at least one sorbent material. In one such aspect, a portion of the condition stream and/or desorbed components can form a third product stream which can be enriched in the first component and/or third component relative to the feed stream. The third product stream can be recovered from at least one of: the second end of the contactor, a condition zone, the sorptive separator and sorptive system.

In one such example, a first portion of the third product stream recovered from the contactor can be enriched in the third component, or can for example, comprise substantially the third component or a larger concentration of the third component relative to the concentration of at least one of the first and/or second component, while a second or subsequent portion of the third product stream recovered from the contactor can be enriched in the first component, can, for example, comprise substantially at least one of the first component and/or second component or a larger concentration of at least one of the first component and/or second component relative to the concentration of the third component. In one such embodiment, employing a first regeneration stream during a first regenerating step and a condition stream during a conditioning step comprising different regeneration mediums (for example, different gasses and/or different gas compositions) and streams, can advantageously reduce the consumption of at least one of the first regeneration or condition mediums and streams for regeneration of the at least one sorbent material or sorptive process.

In an exemplary such embodiment, the conditioning step can also reduce the temperature of the at least one sorbent material and contactor to a temperature, for example, less than a temperature during the first regenerating step, due to desorption of the third component and/or first component sorbed on the at least one sorbent material while reducing the formation of condensation which can advantageously assists in the regeneration process while reducing the energy consumption and operating cost of the sorptive gas separation process. During the conditioning step, the contactor and/or at least one sorbent material can be maintained at a sub-ambient pressure, for example, less than about 100 kPa_{abs} (or for example, between about 70-100 kPa_{abs}, dependent upon factors such as but not limited to the location, elevation, conditions and temperature of the ambient environment at a particular location), and the third product stream can be recovered from the contactor or second end of the contactor, and admitted to combine as a portion of a feed stream such as for admitting into a DCC prior to admitting into the contactor, or into the contactor.

In one such embodiment, such sub-ambient pressure during the conditioning step can advantageously increase the efficiency of the sorptive process, recovery of the component desired for separation, for example, first component, and/or purity of the second product stream.

In an alternative process embodiment according to the present disclosure, during a conditioning step a condition stream can comprise a fluid stream enriched in the first component relative to the feed stream. The condition stream can be provided at a temperature of equal to or greater than an exemplary second temperature threshold, or can be provided at a temperature of equal to or greater than a third temperature threshold (for example, about the upper temperature of the at least one sorbent material during the first regenerating step or during desorbing at least a portion of said first component sorbed on said at least one sorbent material).

In a further embodiment, the condition stream pressure and composition is adjusted and/or controlled to comprise at least one component (for example, the third component) having a partial pressure greater than an equilibrium partial pressure of the said at least one component (for example, the third component), sorbed on the at least one sorbent material in a contactor. This causes the at least one component to sorbed onto the at least one sorbent material.

In a further embodiment, the at least one component is steam and the ratio of moles of steam sorbed or condensing in the pores of the contactor sorbent to the moles of CO₂ removed from the sorbent is less than 6, preferably less than 4, or most preferably less than 3.

When a first portion and/or first period of a second product stream recovered from a contactor (during the first regenerating step) is employed as at least a portion of a feed stream or introduced unmixed during a sorbing step, a second and/or subsequent portion of the second product stream can be recovered from the contactor (during the first regenerating step) and admitted into at least one condenser or condensing heat exchanger to further purify or increase the purity of the first component for example, CO₂.

In a particular process embodiment, a condensing step can be employed to condense and separate at least one condensable component from at least a portion of the second product stream and at least a portion of a third product stream recovered from a contactor and sorptive separator, forming a third product condensate stream and a purified third product stream which can have a reduced concentration of the third component relative to a concentration of the third component in the third product stream recovered from the sorptive separator and contactor.

During a conditioning step, a contactor and/or the at least one sorbent material can be controlled and maintained at a sub-ambient pressure, or less than about 100 kPa_{abs} (or for example, between about 70-100 kPa_{abs}), the condition stream can be admitted into the sorptive separator and contactor to enter the contactor, and/or at least a portion of the third product stream recovered from the contactor can admitted into at least one condenser or condensing heat exchanger. The recovered condensate containing the third component can then be recycled to a vaporizer (for example a steam generator) in order to reduce consumption of the third component by the rapid cycle sorptive separation process.

In an embodiment according to the present disclosure, a sorptive process comprises an feed stream cooling step, a sorbing step, pre-regenerating step, a first regenerating step, and an conditioning step.

In embodiments, a sorbing step, pre-regenerating step, first regenerating step, and conditioning step can be cycled sequentially and repeated substantially continuously or intermittently. The feed stream cooling step, a sorbing step, pre-regenerating step, first regenerating step, and conditioning step can occur substantially simultaneously in an sorptive system, for example, in an sorptive system employing five or more sorptive separators and contactors, or a sorptive system employing a single sorptive separator having a single contactor which moves or cycles through at least five zones within the sorptive separator.

In a further alternative process embodiment according to the present disclosure, a sorptive process can further comprise at least one depressurization step and at least one pressurization step where at least one depressurization step can occur subsequent to a sorbing step and prior to a first regenerating step, and at least one pressurization step can occur subsequent to first regenerating step and prior to conditioning step or a sorbing step.

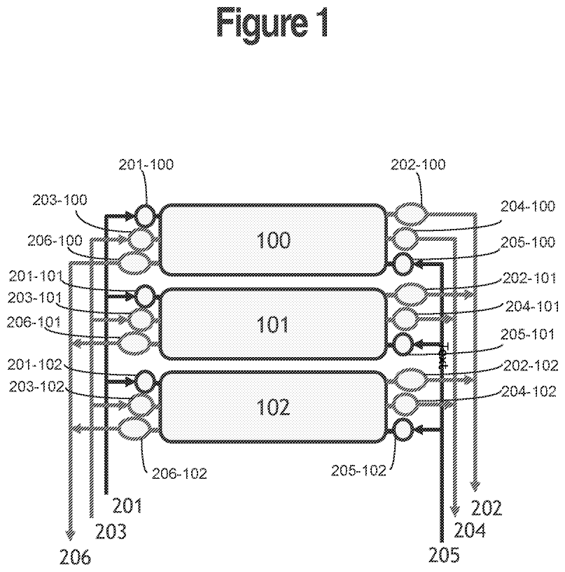

FIG. 1 is a simplified schematic diagram illustrating an exemplary embodiment of a sorptive system and process comprising multiple stationary or fixed contactors 100, 101, and 102, a feed stream conduit 201, a first product stream conduit 202, a condition stream conduit 203, a third product stream conduit 204 for recovering the effluent of the condition stream, a first regeneration stream conduit 205 and a second product stream conduit 206. In between conduits 201, 202, 203, 204, 205 and 206, and contactors 100, 101, and 102, a valve is fluidly connected to control the flow of a fluid stream into and out of a contactor during each process step. The sorptive separation system further comprise a valve 201-100, a valve 202-100, a valve 203-100, a valve 204-100, a valve 205-100, a valve 206-100, fluidly connected to contactor 100; a valve 201-101, a valve 202-101, a valve 203-101, a valve 204-101, a valve 205-101, a valve 206-101, fluidly connected to contactor 101; and a valve 201-102, a valve 202-102, a valve 203-102, a valve 204-102, a valve 205-102, a valve 206-102, fluidly connected to contactor 102.

Table 1 below illustrate the valve position for the valves and sorptive separation system shown in FIG. 1. The rows of the table represent for a contactor, a valve and its position, while the columns of the table represent at a period in time a corresponding step of a sorptive process for each contactor. Valves are identified by an associated conduit and contactor, for example, a valve 201-100 represents a valve fluidly connected in and/or between conduit 201 and contactor 100. In FIG. 1 and the table below illustrate an embodiment sorptive process having three steps, a sorbing step A, a first regenerating step B, and a conditioning step C, for each contactor. In the table below, valves are shown as open by an “O” and shown as closed by an “X”. In this example contactors 100, 101, and 102 are operated out of phase or substantially sequentially to create a semi-continuous flow for a feed stream, a second product stream and a condition gas stream. The three steps exemplified are a sorbing step using a feed stream, a first regenerating step using a first regeneration stream, and a conditioning step using a condition stream.

TABLE 1

| | | | | | | |
|---|---|---|---|---|---|---|
| Period | 1 | 2 | 3 | 4 | 5 | 6 |

Contactor 100

| Step | A | B | C | A | B | C |
|---|---|---|---|---|---|---|
| 201-100 | ◯ | X | X | ◯ | X | X |
| 202-100 | ◯ | X | X | ◯ | X | X |
| 203-100 | X | X | ◯ | X | X | ◯ |
| 204-100 | X | X | ◯ | X | X | ◯ |
| 205-100 | X | ◯ | X | X | ◯ | X |
| 206-100 | X | ◯ | X | X | ◯ | X |

Contactor 101

| Step | B | C | A | B | C | A |
|---|---|---|---|---|---|---|
| 201-101 | X | X | ◯ | X | X | ◯ |
| 202-101 | X | X | ◯ | X | X | ◯ |
| 203-101 | X | ◯ | X | X | ◯ | X |
| 204-101 | X | ◯ | X | X | ◯ | X |
| 205-101 | ◯ | X | X | ◯ | X | X |
| 206-101 | ◯ | X | X | ◯ | X | X |

Contactor 102

| Step | C | A | B | C | A | B |
|---|---|---|---|---|---|---|
| 201-102 | X | ◯ | X | X | ◯ | X |
| 202-102 | X | ◯ | X | X | ◯ | X |
| 203-102 | ◯ | X | X | ◯ | X | X |
| 204-102 | ◯ | X | X | ◯ | X | X |
| 205-102 | X | X | ◯ | X | X | ◯ |
| 206-102 | X | X | ◯ | X | X | ◯ |

In one system embodiment for carrying out the process of the invention, sorbent contactors are stationary or fixed contactors which are grouped in sets of 3 or more contactors operated on a coordinated cycle speed and phase. Each contactor is connected to at least 3 inlet conduits each having a valve, and 3 outlet conduits each having a valve, where the valves are operable to enable or disable a fluid connection between each contactor and conduit. Valves can be, for example, rotary valves, two way valves, three way valves, gate valves, and butterfly valves, preferably with a reduced piping distance and/or volume between a valve and a contactor.

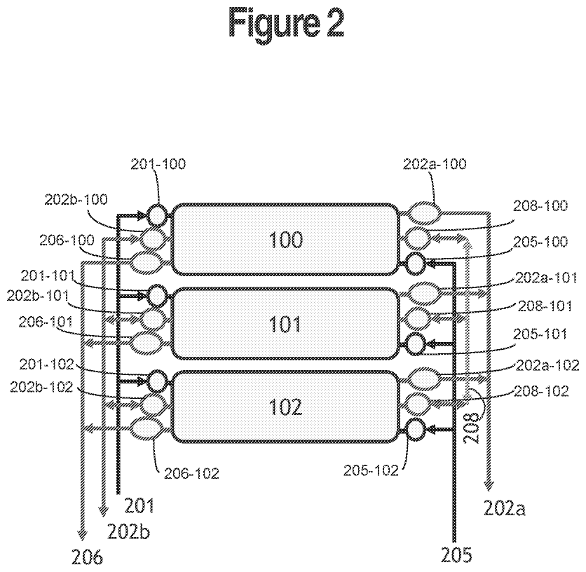

FIG. 2 is a simplified schematic diagram illustrating an exemplary embodiment of a sorptive system and process comprising multiple stationary or fixed contactors 100, 101, and 102, a feed stream conduit 201, first product stream conduits 202a and 202b, a first regeneration stream conduit 205, a second product stream conduit 206, and a first product recycle conduit 208. At each fluid connection between a conduit and a contactor, a valve is fluidly connected to control a fluid stream into and out of a contactor during each process step. Valves are identified by an associated conduit and contactor for example, a valve 201-100 represents a valve fluidly connected in and/or between conduit 201 and contactor 100. The sorptive separation system further comprise a valve 201-100, a valve 202a-100, a valve 202b-100, a valve 208-100, a valve 205-100, a valve 206-100, fluidly connected to contactor 100; a valve 201-101, a valve 202a-101, a valve 202b-101, a valve 208-101, a valve 205-101, a valve 206-101, fluidly connected to contactor 101; and a valve 201-102, a valve 202a-102, a valve 202b-102, a valve 208-102, a valve 205-102, a valve 206-102, fluidly connected to contactor 102.

FIG. 2 illustrate an embodiment sorptive process having three steps, A1, A2, and B, for each contactor. Table 2 below illustrate the corresponding valve position for the valves and sorptive separation system shown in FIG. 2. The rows of the tables represent for a contactor, a valve and its position, while the columns of the table represent at a period in time a corresponding step of a sorptive process for each contactor. Valves are identified by an associated conduit and contactor, for example, a valve 201-100 represents a valve fluidly connected in and/or between conduit 201 and contactor 100. Valves are shown as open by an (“O”) and which valves are shown as closed by an (“X”). In this example, contactors 100, 101, and 102 are operated out of phase to create a semi-continuous flow for a feed stream, a second product stream and a first product stream. The three steps exemplified are a first sorbing step A1, a second sorbing step A2, and a first regenerating step B using a first regeneration stream. In this example two sorbent contactors are operated substantially in series enabling to improve the recovery of a first component while also increasing the saturation level of the first component in a contactor during a second sorbing step, prior to a first regenerating step. Condensing units (not shown in FIG. 2) can be fluidly connected and employed in conduit 208 to improve a sorbent process and system performance for some sorbent materials by removing a third component from a first product recycle stream, for example, part of a sorbing step, such as sorbing step A1, can offer similar results as a typical conditioning step in other sorptive processes, during conditions where the feed stream admitted during sorbing step A1 comprise a relatively low concentration in the third component which enables stripping of the third component sorbed on a sorbent material while sorbing the first component.

TABLE 2

| | | | | | | |
|---|---|---|---|---|---|---|
| Period | 1 | 2 | 3 | 4 | 5 | 6 |

Contactor 100

| Step | A1 | A2 | B | A1 | A2 | B |
|---|---|---|---|---|---|---|
| 201-100 | X | ◯ | X | X | ◯ | X |
| 202a-100 | X | X | X | X | X | X |
| 202b-100 | ◯ | X | X | ◯ | X | X |
| 208-100 | ◯ | ◯ | X | ◯ | ◯ | X |
| 205-100 | X | X | O | X | X | ◯ |
| 206-100 | X | X | O | X | X | ◯ |

Contactor 101

| Step | A2 | B | A1 | A2 | B | A1 |
|---|---|---|---|---|---|---|
| 201-101 | ◯ | X | X | ◯ | X | X |
| 202a-101 | X | X | X | X | X | ◯ |
| 202b-101 | X | X | ◯ | X | X | X |
| 208-101 | ◯ | X | ◯ | ◯ | X | ◯ |
| 205-101 | X | ◯ | X | X | ◯ | X |
| 206-101 | X | ◯ | X | X | ◯ | X |

Contactor 102

| Step | B | A1 | A2 | B | A1 | A2 |
|---|---|---|---|---|---|---|
| 201-102 | X | X | ◯ | X | X | ◯ |
| 202a-102 | X | X | X | X | ◯ | X |
| 202b-102 | X | ◯ | X | X | X | X |
| 208-102 | X | ◯ | ◯ | X | ◯ | ◯ |
| 205-102 | ◯ | X | X | ◯ | X | X |
| 206-102 | ◯ | X | X | ◯ | X | X |

In sorptive gas separation applications for separating a first component from a flue gas stream of a combustion process, with a fraction of the water removed, a partial pressure of water in a feed stream admitted into a contactor during a sorbing step can be much lower than during a first regenerating step.

FIG. 2 illustrates a flow direction reversal when switching between first sorbing step A1 and second sorbing step A2, however, reversal of the flow direction is not required for implementation of the technology.

In one further system embodiment for carrying out the process of the invention, sorbent contactors are stationary or fixed which are grouped in sets of 3 or more contactors and operated on a coordinated cycle speed and phase. Each contactor is connected to at least 3 inlet conduits each having a valve and 3 outlet conduits each having a valve where the valves are operable to enable or disable a fluid connection between each contactor and conduit. Valves can be, for example, rotary valves, two way valves, three way valves, gate valves, and butterfly valves, preferably with a reduced piping distance and/or volume between a valve and a contactor. At least one conduit can be used to connect contactors in series allowing the process effluent such as an effluent stream of a first contactor to become at least a portion of a feed stream of a second contactor.

In an alternative embodiment, a sorptive separation process can use a sorptive system comprising the same physical layout of the sorptive system as in FIG. 2. However, the sorbing step is split into three sorbing steps, a first sorbing step A1 with a contactor performing step A1 is fluidly connected in series and upstream of a contactor performing step A3, a second sorbing step A2 with a contactor operated to enable a feed stream to flow straight through the contactor, sorbing and separating the first component from the feeds stream, producing a first product stream and recovering the first product stream, and a third sorbing step A3 operated in series to drive and increase the saturation of the sorbent in a contactor which can also be called a feed saturation step.

Table 3 below illustrate an embodiment sorptive process having three sorbing steps, first sorbing step A1, second sorbing step A2, third sorbing step A3, and a first regenerating step B using a first regeneration stream, for each contactor and the corresponding valve position for the valves and sorptive separation system shown in FIG. 2. The rows of the tables represent for a contactor, a valve and its position, while the columns of the table represent at a period in time a corresponding step of a sorptive process for each contactor. Valves are identified by an associated conduit and contactor, for example, a valve 201-100 represents a valve fluidly connected in and/or between conduit 201 and contactor 100. Valves are shown as open by an (“O”) and which valves are shown as closed by an (“X”).

TABLE 3

| | | | | | | |
|---|---|---|---|---|---|---|
| Period | 1 | 2 | 3 | 4 | 5 | 6 |

Contactor 100

| Step | A1 | A2 | A3 | B | A1 | A2 |
|---|---|---|---|---|---|---|
| 201-100 | X | ◯ | ◯ | X | X | ◯ |
| 202a-100 | X | ◯ | X | X | X | ◯ |
| 202b-100 | ◯ | X | X | X | ◯ | X |
| 208-100 | ◯ | X | ◯ | X | ◯ | X |
| 205-100 | X | X | X | ◯ | X | X |
| 206-100 | X | X | X | ◯ | X | X |

Contactor 101

| Step | A2 | A3 | B | A1 | B | A1 |
|---|---|---|---|---|---|---|
| 201-101 | ◯ | ◯ | X | X | X | X |
| 202a-101 | ◯ | X | X | X | X | ◯ |
| 202b-101 | X | X | X | ◯ | X | X |
| 208-101 | X | ◯ | X | ◯ | X | ◯ |
| 205-101 | X | X | ◯ | X | ◯ | X |
| 206-101 | X | X | ◯ | X | ◯ | X |

Contactor 102

| Step | A3 | B | A1 | A2 | A1 | A2 |
|---|---|---|---|---|---|---|
| 201-102 | ◯ | X | X | ◯ | X | ◯ |
| 202a-102 | X | X | X | ◯ | ◯ | X |
| 202b-102 | X | X | ◯ | X | X | X |
| 208-102 | ◯ | X | ◯ | X | ◯ | ◯ |
| 205-102 | X | ◯ | X | X | X | X |
| 206-102 | X | ◯ | X | X | X | X |

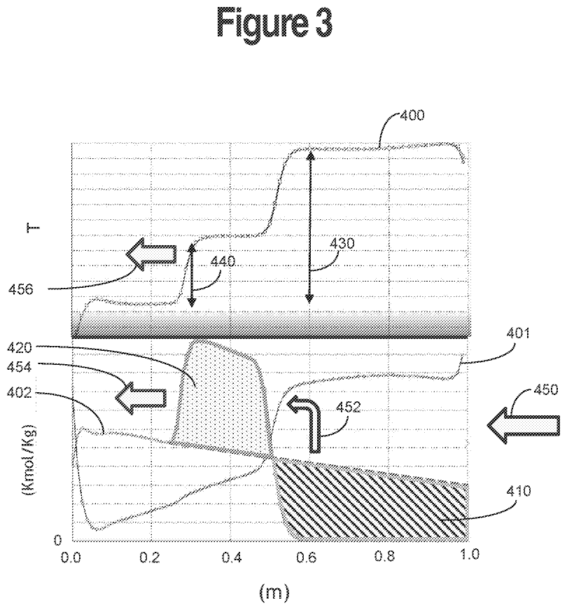

In this example, contactors 100, 101, and 102 are operated out of phase to indicate how a plurality of contactors can be used to create a semi-continuous flow for a feed stream, a feed effluent or a first product stream, and second and third product streams. Condensing units (not shown in FIG. 3) can be fluidly connected and employed in conduit 208 to improve the sorbent process and system performance for some sorbent materials by removing a third component from a first product stream. One familiar in the art would note that the flow resistance in second sorbing step A2 with only one sorbent contactor in the path of the feed stream to the first product stream conduit 202a, is significantly lower than the flow resistance in the first sorbing step A1 or third sorbing step A3, when two sorbent contactor bed are operated in series. Because of this is the pressure in conduit 201 and conduits 202a or 202b, are substantially constant up to the valves and a higher flow will be experience by the sorbent contactor during second sorbing step A2. It is desirable to minimize the flow resistance of the feed stream through the sorption machine and contactors to enable faster cycling of the process and/or reduction in energy used to drive an option fan or blower which can be used to pressurize or move the feed stream.

FIG. 2 illustrates a flow direction reversal when switching between first sorbing step A1 and second sorbing step A2, however, reversal of the flow direction is not required for implementation of the technology.

FIGS. 3A and 3B are plots illustrating the result of numerical simulations for a MOF sorbent based contactor showing a snapshot of temperature and CO₂ and H₂O loading profiles near a mid-point in time of a first regenerating step employing a steam stream as a first regeneration stream where the steam injection is performed in a counter-flow direction relative to a direction of flow of a feed stream in the contactor during a sorbing step. FIG. 3A shows temperature on the Y-axis, axial position of a 1 meter contactor on the X-axis and a temperature plot 400 as function of axial position. FIG. 3B shows a sorbed species loading on the Y-axis, axial position of the 1 meter contactor on the X-axis, a plot 401 showing an amount of the third or water component sorbed on the sorbent in Kmol per Kg of sorbent (or water loading) as a function of axial position, a plot 402 showing an amount of the first or carbon dioxide component sorbed on the sorbent in Kmol per Kg of sorbent (or CO₂ loading) as a function of axial position, an area 410 representing desorbed first or carbon dioxide component, and an area 420 representing re-sorbed first or carbon dioxide component. Both graphs in FIGS. 3A and 3B represent a point in time during a regeneration step. Arrows 454 and 456 represent the direction of motion of the temperature front and arrow 452 represent the first or carbon dioxide component desorption front during the regenerating step as a regeneration or steam stream is admitted into the contactor from axial location 1.0 m to of the contactor, as shown by arrow 450. A temperature change 430 represents a change in temperature as a result of sorption of a third or water component while a temperature change 440 represents a change in temperature as a result of the first or carbon dioxide component re-sorbing.

In this case pure steam at about 1 Bara was simulated and admitted into the contactor from axial location 1.0 m to 0.0 m of the contactor, as shown by arrow 450. In FIG. 3A, we can see a large increase in temperature or a temperature change 430 at about a 0.6 m to 1.0 m axial position of the contactor where steam is sorbed releasing a heat of adsorption and a second smaller increase in temperature, or a temperature change 440 at about a 0.3 m to 0.5 m axial position of the contactor where some of the CO₂ has been re-sorbed within the contactor on its way out of the contactor.

In FIG. 3B, shaded areas indicate the change in CO₂ loading versus the loading profile recorded at the end of a sorbing step. At mid-point through the first regenerating step almost no CO₂ has escaped from the contactor due to the strong increase in CO₂ sorption capacity when contacted by the high concentration second product effluent formed with the contactor. An area 410 is representative of the integral of desorbed first or CO₂ component between axial position 0.6 m to 1 m, which closely matches an area 420 which represents an amount of CO₂ re-sorbed between axial position 0.3 m to 0.5 m. This phenomena closely resembles a chromatographic purification steps where the desired product get concentrated within the chromatic columns.

In order to minimize the use of excess steam to push the CO₂ out of the contactor, it is important that the thermal and gas composition front travelling through the contactor during the first regenerating step be moving at the same speed through-out the contactor. The re-sorption itself has a low impact of the process energetics as the heat of adsorption is stored in the sorbent structure and is partially returned during desorption or can displace some of the steam or energy desired to increase the temperature of the contactor during a first regenerating step. An arrow 454 and an arrow 456 represent the direction of motion of the temperature front and an arrow 452 represent the first or carbon dioxide component desorption front during the first regenerating step.

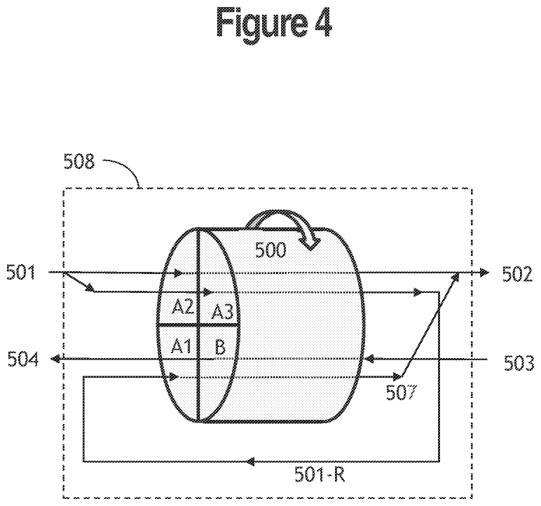

FIG. 4 is a simplified schematic diagram illustrating an exemplary embodiment of a sorptive system comprising a RAM 509 having a contactor 500 further comprising at least a sorbent and configured with 4 stationary zones or segments (for the associated process step or conditions) where the zones or segments are substantially fluidly separate within contactor 500. A segment A2 and a segment A3, contactor 500 and RAM 509 are fluidly connected to receive a feed stream 501. An outlet of segment A2 is fluidly connected to recover a second fraction of first product stream or an effluent stream 502, while an outlet of segment A3 is fluidly connected to recover a third fraction of a first product stream or an effluent stream 501-R from an outlet of segment A3 and to admit effluent stream 501-R into an inlet of a segment A1. An outlet of segment A1 is fluidly connected to recover a first fraction of first product stream or an effluent stream 507 from segment A1 and to combine effluent stream 507 into an effluent stream 502. RAM 509 and contactor 500 are fluidly connected to receive a regeneration stream 503 in a segment B and to recover a second product stream 504 from segment B.

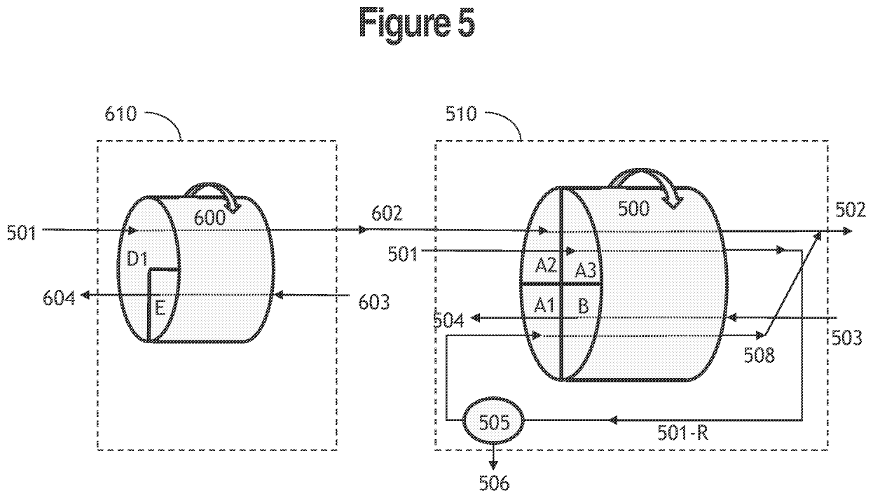

In an embodiment, contactor 500, rotates around a central axis, where contactor 500 moves to different feed and effluent fluid connectors placed on stator plates (not shown in FIG. 5) perpendicular to the axis of rotation of contactor 500. Feed stream 501, is directed to and admitted into segments A2 and A3, while first product stream or effluent stream 501-R is generated at the exit of and recovered from segment A3. Effluent stream 501-R is returned and admitted as a feed stream into segment A1 during a pre-feed or a first sorbing step to improve recovery. Effluent stream 507 can be combined with effluent stream 502 recovered from segment A2. Regeneration stream 503 is admitted into a segment B, in a counter-flow direction to a direction of a flow of feed stream 501 in segments A2 and A3 during their respective sorbing steps, generating second product stream 504, enriched in first component relative to feed stream 501.

In a particular embodiment, contactor 500 cycles between 4 steps, a pre-feed or first sorbing step which includes recycling and admitting at least a portion of effluent stream 501-R to improve recovery of the first component as well as conditioning the sorbent by cooling and removing at least a fraction of the third component sorbed on the sorbent within segment A1, a second sorbing step for sorbing of the first component and increasing the recovery of the first component to a recovery of greater than about 90%, a feed saturation or third sorbing step where feed stream 501 is admitted into segment A3 and contactor 500 resulting in reducing recovery of the first component recovery to less than about 80% and a regenerating step where regeneration stream 503 with high partial pressure in a third component relative to the equilibrium saturation level of the portion of contactor 500 in segment A3 during the third sorbing is admitted into segment B and contactor 500 to cause the exothermic sorption or condensation of the third component in the sorbent with a substantially simultaneous release of the first component sorbed on the sorbent.

FIG. 5 is a schematic representation of an embodiment of the invention having two-stages configured with rotary adsorption machines (RAMs) having a second stage RAM operated similarly from described in FIG. 4. In a first stage, a first RAM 610 is used to remove a fraction of the moisture from a flue gas where a second fraction of the flue gas is used as a feed stream 501 for first RAM 610. First RAM 610 is fluidly connected to recover an effluent stream 602 and admit the effluent stream 602 as a feed stream to a segment A2 of the second stage or a second RAM 510, for separation of the first component or carbon dioxide from the feed streams. A first fraction of the flue gas bypasses first RAM 610 and is used as a feed stream 501 for a segment A3 of second RAM 510.

In FIG. 5 an exemplary embodiment of a sorptive system comprising a first RAM 610 having a contactor 600 further comprising at least a first sorbent and configured with two zones or segments, a second RAM 510 having a contactor 500 further comprising at least a second sorbent and configured with four zones or segments. The zones or segments for contactor 600 and contactor 500 are substantially fluidly separate. First RAM 610 and contactor 600 are fluidly connected to receive and/or admit a second fraction of a feed stream 501 into a segment D1 and contactor 600, and to recover a first product stream or an effluent stream 602 from segment D1 and contactor 600; and to receive and/or admit a regeneration stream 603 into a segment E and to recover a effluent stream 604 from segment E which can contain a high concentration of the third component or water relative to regeneration stream 603.

In second RAM 510, a segment A2, contactor 500 and RAM 510 are fluidly connected to receive effluent stream 602 from a segment D1 of contactor 600 and first RAM 610 as a feed stream while a segment A3, contactor 500 and RAM 510 are fluidly connected to receive a first fraction of said feed stream 501 as a feed stream. An outlet of segment A2 is fluidly connected to recover a second fraction of first product stream or an effluent stream 502, while an outlet of segment A3 is fluidly connected to recover a third fraction of first product stream or an effluent stream 501-R from an outlet of segment A3 and to admit effluent stream 501-R into an inlet of a segment A1 as a feed stream. An outlet of segment A1 is fluidly connected to recover a first fraction of first product stream or an effluent stream 508 from segment A1 and to combine effluent stream 508 with effluent stream 502. Segment B of RAM 510 and contactor 500 are fluidly connected to receive a regeneration stream 503 and to recover a second product stream 504 from segment B. The first sorbent in contactor 600 can or cannot be the same sorbent as the second sorbent in contactor 500.

In one aspect, first RAM 610, having contactor 600 is configured in front or upstream of second RAM 510, having contactor 500 where second RAM 510 is used to separate and remove a first component from a multi-component fluid stream used as a feed stream 501. A first fraction of the flue gas or feed stream 501 bypasses first RAM 610 and is used as a feed stream 501 for segment A3 of second RAM 510.

First RAM 610 and contactor 600 is used to remove a third component from second fraction of feed stream 501. In a case where a feed stream is a combustion flue gas, first RAM 610 and contactor 600 is employed for the removal of the third component or water. During a sorbing step, second fraction of feed stream 501 is admitted into and passed through segment D1 of contactor 600 where the third component is sorbed and separated from second fraction of feed stream 501 by the first sorbent. The remaining non-sorbed components produce effluent stream 602 partially depleted in the third component (for example water) relative to feed stream 501. As contactor 600 rotates around an axis, sorbents in segment E are regenerated by admitting a dry gas stream such as regenerating stream 603, for example, an air stream with a low humidity, producing effluent stream 604 enriched in the third component relative to second fraction of feed stream 501 through a partial pressure swing, a pressure swing, or a vacuum swing. Effluent stream 604 is then recovered from segment E, contactor 600 and first RAM 610.

Effluent 602 from segment D1 of first RAM 610 is then used as a feed stream for segment A2 of second RAM 510. Second RAM 510 and contactor 500 is operated as described in FIG. 4 except for the use of a conditioned (or dried) feed steam, for example, use of effluent stream 602 recovered from segment D1 of RAM 610 as a feed stream for segment A2 of RAM 510, and the addition of a condenser 505 to remove a fraction of the third component from effluent stream 501-R, as a condensate stream 506. In the case of combustion flue gas purification, removal of the water from effluent stream 602 for use as a feed stream for admittance into segment A2 during a second sorbing step, and/or from effluent stream 501-R for admittance into segment A1 during a pre-feed or first sorbing step greatly enhance the performance of some MOF based sorbents which have competitive adsorption of water on CO₂ adsorption sites.

In a particular embodiment, a sorptive system using the process described comprise two sorption machines or RAMs fluidly connected in series, for example, RAM 610 and RAM 510 where a first RAM or first RAM 610 removes the majority of the third component in a range of greater than about 30% and less than about 80% from a feed stream, for example, second fraction of feed stream 501, producing an effluent or product stream with a low humidity, for example, effluent stream 602, which can then be used as a feed stream for a segment A2 of second RAM 510, operated to recover the first component contained in the feed gas, for example, first fraction of feed stream 501 and second fraction of feed stream 501.

In a further embodiment, a RAM can further comprise a condenser using a cooling stream or a pressurization and expansion loop fluidly connected to recover a third fraction of first product stream from a contactor and RAM and to recycle and admit the third fraction of first product stream or effluent stream as a feed stream into the contactor and RAM. The condenser can be fluidly connected to recover first product stream or effluent stream 501-R from segment A3 of contactor 500 and to recycle and admit first product stream or effluent stream 501-R as a feed stream into segment A1 of contactor 500.

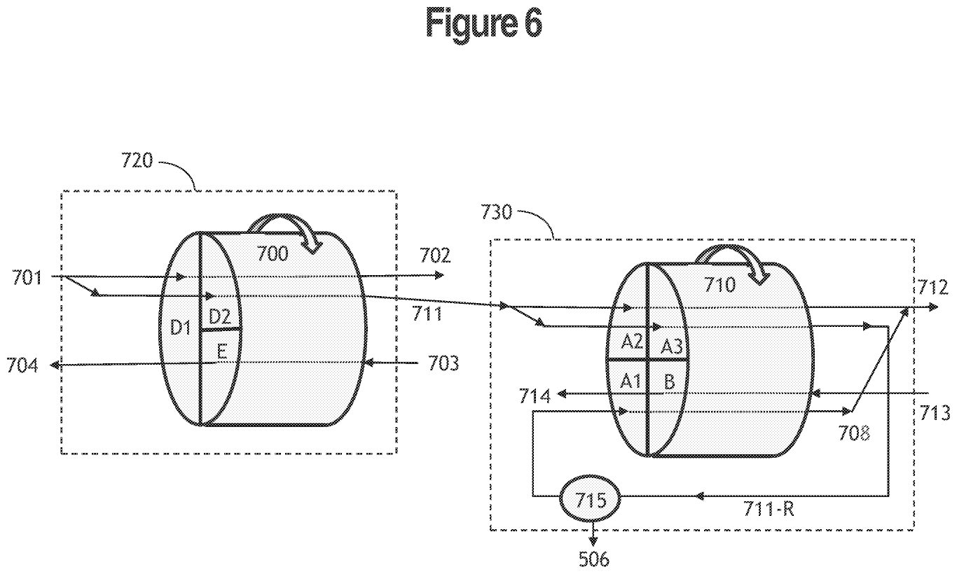

FIG. 6 is a schematic representation of an embodiment of the invention having two-stages configured with rotary adsorption machines (RAMs). In a first stage, a first RAM 720 operates on a simplified cycle with two sorbing steps and a regenerating step. A second fraction of first product stream containing a greater fraction or concentration of the first component relative to a first fraction of first product stream from first RAM 720 is directed to a second stage and a second RAM 730 to increase recovery of the first component.

In FIG. 6, an exemplary embodiment of a sorptive system to use the process described in this disclosure comprising first RAM 720 having a contactor 700 further comprising at least a first sorbent and configured with three zones or segments, second RAM 730 having a contactor 710 further comprising at least a second sorbent and configured with four zones or segments. The zones or segments for contactor 700 and contactor 710 are substantially fluidly separate. In one aspect, first RAM 720 having contactor 700, is configured and fluidly connected in front or upstream of second RAM 730 having contactor 710. A segment A2 and a segment A3 of contactor 710 and second RAM 730 is fluidly connected to receive and admit as a feed stream, a second fraction of first product stream or an effluent stream 711 from a segment D2 of contactor 700 and first RAM 720. Segment D1 and segment D2 of contactor 700 and first RAM 720 are fluidly connected to receive a feed stream 701. First RAM 720 and segment D1 is fluidly connected to recover a first fraction of a first product stream or effluent stream 702. In second RAM 730, a segment A2 and a segment A3, contactor 710 and RAM 730 are fluidly connected to receive a feed stream from effluent stream 711 from a segment D2 of contactor 700 and first RAM 720. An outlet of segment A2 is fluidly connected to recover a second fraction of first product stream or an effluent stream 712, while an outlet of segment A3 is fluidly connected to recover a third fraction of first product stream or an effluent stream 711-R from an outlet of segment A3 and to admit effluent stream 711-R into an inlet of a segment A1. An outlet of segment A1 is fluidly connected to recover a first fraction of first product stream or an effluent stream 708 from segment A1 and to combine effluent stream 708 with effluent stream 712. RAM 730 and contactor 710 are fluidly connected to receive a regeneration stream 713 in a segment B and to recover a second product stream 714 from segment B. The first sorbent in contactor 700 can or cannot be the same sorbent as the second sorbent in contactor 710. Both first RAM 720 and second RAM 730 are used to separate and recover a first component, for example, carbon dioxide, from a multicomponent gas stream, for example, a flue gas stream, which is employed as a feed stream 701. First RAM 720 and contactor 700 uses a simpler cycle having less process steps which enables a higher productivity but lower recovery of the first component. Second RAM 730 and contactor 710 uses a complex cycle having more process steps resulting in increased recovery from a feed stream which is a fraction of an effluent stream from first RAM 720 and contactor 700.

In one aspect, first RAM 720 and contactor 700 is configured having three segments or three process steps, where feed stream 701 is admitted into first RAM 720, a segment D1, a segment D2, and contactor 700, to come in contact with the first sorbents. During a first sorbing step corresponding to and occurring in segment D1, the first component is separated from feed stream 701 and removed at greater than about 90% recovery as first fraction of a first product stream or effluent stream 702, which can be discarded, for example, released to the atmosphere. Contactor 700 then moves or rotates where a feed saturation step or second sorbing step occurs in segment D2 where recovery of the first component reduces significantly relative to the first sorbing step occurring in segment D1. A second fraction of first product stream or effluent stream 711 is recovered from contactor 700 at segment D2 and is used as a feed stream for second RAM 730 and contactor 710. A first regeneration stream 703, comprise a high partial pressure in a third component relative to an equilibrium saturation level of the sorbent during the previous or second sorbing step occurring in segment A2, is admitted into first RAM 720, segment E and contactor 700, causing an exothermic sorption or condensation of the third component on the sorbent in segment E with a simultaneous release of the first component sorbed in and/or on the sorbent. A second product stream 704 is recovered from segment E and can be further purified prior to capturing the first component as a product.

In another aspect, second RAM 730, contactor 710, moves or rotates around a central axis to different feed and effluent fluid connectors placed on stator plates (not shown in FIG. 6) perpendicular to the axis of rotation of contactor 710. The effluent stream 711 is directed and admitted as a feed stream for second RAM 730 and segments A2 and A3, while third fraction of first product stream generated in and recovered from segment A3 as effluent stream 711-R is returned as a feed stream in segment A1 during a pre-feed or first sorbing step to improve recovery. A condenser 715 is fluidly connected to segment A3 to separate and remove a fraction of condensable third component contained in effluent stream 711-R, and to admit a dried effluent stream 711-R as a feed stream into segment A1. A condensate stream 506 is recovered from condenser 715. A first fraction of first product stream or an effluent stream 708 recovered from segment A1 is combined with a second fraction of first product stream or effluent stream 712. A first regeneration stream 713 is admitted into second RAM 730, segment B and contactor 710, to cause an exothermic sorption or condensation of the third component in the sorbent with a substantially simultaneous release of the first component sorbed on the sorbent. A second product stream 714, is recovered from segment B and can be further purified prior to capturing the first component as a product.

In a particular embodiment, a sorptive system using the process described comprise two sorption machines or RAMs fluidly connected in series, for example, a first RAM and a second RAM where the first RAM is fluidly connected upstream of the second RAM, where a first sorption machine or first RAM produces two fractions of a first product stream, for example, a first fraction of a first product stream and a second fraction of a first product stream. The first fraction of the first product stream having a low breakthrough of the first component or less than about 10% of the flux of first component, for example, carbon dioxide, contained in the feed stream during a same period of time as the collection, and the second fraction of the first product stream having a higher breakthrough of first component, wherein the second fraction of first product stream is directed to and admitted as a feed stream to the second RAM or second sorption machine and wherein during at least one step of a sorptive process comprise a partial pressure swing and generating a heat of adsorption of a third component equal to or greater than about 1.5 times a heat of desorption of a first component recovered in the process in at least one sorption machine or RAM. In one aspect, the heat of adsorption generated is used to desorb a component from a sorbent.

In a further embodiment, a first sorption machine or RAM operating with a simplified cycle comprise a first component productivity per cubic meter of sorbent contactor volume greater than about 1.5 times a productivity per meter cube of sorbent contactor volume of a second sorption machine or RAM.

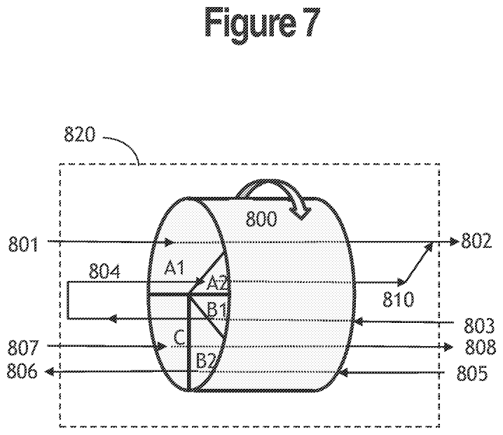

FIG. 7 is a simplified schematic diagram illustrating an exemplary embodiment of a sorptive system enabling the use of the separation process described in this disclosure comprising a RAM 820, having a contactor 800 further comprising at least a sorbent and configured with five zones or segments. The zones or segments for contactor 800 are substantially fluidly separate. RAM 820 and contactor 800 is fluidly connected to receive and/or admit a feed stream 801 into a segment A1, and to recover a first fraction of a first product stream 802 from segment A1; to receive and/or admit a pre-regeneration stream 803 into a segment B1 and to recover a first fraction of a second product stream 804 from segment B1; to recycle and admit first fraction of a second product stream 804 into segment A2, and to recover a second fraction of first product stream 810 from segment A2; to receive and/or admit a regeneration stream 805 into a segment B2 and to recover a second fraction of a second product stream 806 from segment B2; and to receive and/or admit a condition stream 807 into a segment C and to recover a third product stream 808 from segment C. Segment A2 can be fluidly connected to combine second fraction of first product stream 810 with first fraction of a first product stream 802.

In an embodiment, feed stream 801 is admitted into RAM 820 and contactor 800 in segment A1 to come in contact with sorbents in segment A1 where at least a portion of a first component is sorbed by the sorbent, producing first fraction of first product stream 802, which is recovered from contactor 800, segment A1, and RAM 820. Regenerating steps are split into two consecutive regenerating steps which occur in segment B1 and segment B2, where pre-regeneration stream 803 is admitted into contactor 800 in segment B1 and regeneration stream 805 is admitted into contactor 800 in segment B2, causing the exothermic sorption or condensation of the third component into the sorbent with a simultaneous release of the first component sorbed in or on the sorbent. First fraction of second product stream 804 is recovered from contactor 800 and segment B1, and is redirected and admitted into segment A2 and contactor 800, where first fraction of a second product stream 804 is partially depleted in the first component relative to feed stream 801. Second fraction of first product stream 810 is produced in contactor 800 and segment A2, which can them be recovered from contactor 800 and segment A2 and combined with first fraction of the first product stream 802. Second fraction of the second product stream 806 is recovered from contactor 800 and segment B2 and can be further purified to collect the first component. Condition stream 807 is admitted into contactor 800 in segment C to produce third product stream 808 which is then recovered from contactor 800, segment C and RAM 820. Pre-regeneration stream 803 and regeneration stream 805 can be comprise the same source and composition, but need not be.

In a particular embodiment, a sorptive system using the process described herein comprise one RAM with at least five segments.

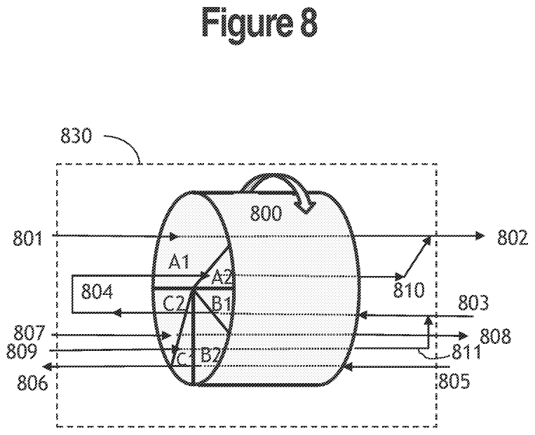

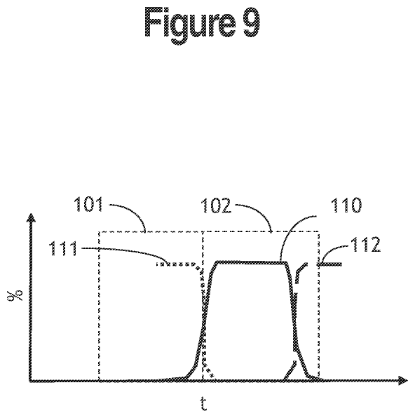

FIG. 8 is a simplified schematic diagram illustrating an exemplary embodiment of a sorptive system enabling the use of the separation process described in this disclosure comprising a RAM 830, having a contactor 800 further comprising at least a sorbent and configured with six zones or segments. The zones or segments for contactor 800 are substantially fluidly separate. RAM 830 and contactor 800 is fluidly connected to receive and/or admit a feed stream 801 into a segment A1, and to recover a first fraction of a first product stream 802 from segment A1; to receive and/or admit a pre-regeneration stream 803 into a segment B1 and to recover a first fraction of a second product stream 804 from segment B1; to recycle and admit first fraction of a second product stream 804 into segment A2, and to recover a second fraction of first product stream 810 from segment A2; to receive and/or admit a regeneration stream 805 into a segment B2 and to recover a second fraction of a second product stream 806 from segment B2; to receive and/or admit a condition stream 807 into a segment C2 and to recover a second fraction of third product stream 808 from segment C2; to receive and/or admit a pre-condition stream 809 into a segment C1 and to recover a first fraction of third product stream 811 from segment C1; and to admit first fraction of third product stream 811 to combine with pre-regeneration stream 803 and/or admit into segment B1. Segment A2 can be fluidly connected to combine second fraction of first product stream 810 with first fraction of a first product stream 802. In this example the connections and streams presented in FIG. 8 are present in FIG. 9 with the addition of a segment for a conditioning step where the first fraction of the third product stream is recycled and combined with the pre-regeneration stream for use in a pre-regenerating step. A high concentration of the third component can be present in first fraction of the third product stream 811 due to an elevated temperature of the contactor in segment C1, and recycling of the first fraction of the third product stream can be beneficial in raising the temperature of contactor 800 in segment B1 during a pre-regeneration step. Pre-regeneration stream 803 and regeneration stream 805 can be comprise the same source and composition, but need not be.

In a particular embodiment, a sorptive system using the process described herein comprise one RAM with at least six segments.

FIG. 9 is a graph showing of a first or carbon dioxide component concentration plot 110, a second or nitrogen component concentration plot 111, and a third or water component concentration plot 112, component concentration versus time during a regenerating step as observed in a second product stream. A concentration is shown on the Y-axis and time is shown on the X-axis. A first fraction of a second product stream 101 and comprise a greater fraction of a second component or nitrogen relative to a first component or carbon dioxide, while a second fraction of second product stream 102, comprise a greater fraction of the first component relative to the second component and also illustrate the splitting of the second product stream into a second product stream low in purity of the first component and a second product stream high in purity of the first component. A first fraction of a second product stream 101 can be recycled to a sorbing step or a pre-regeneration step. A second fraction of second product stream 102 can be recovered and admitted into a condenser to remove water from the mixture.

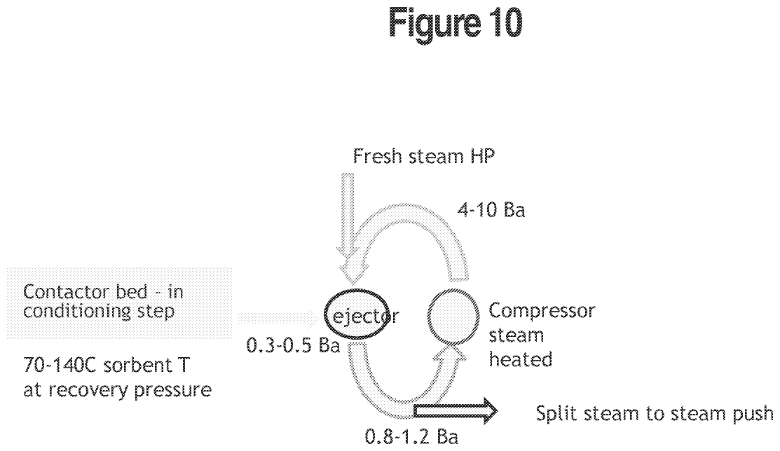

FIG. 10 is a simplified flow diagram illustrating an embodiment of a combination of an ejector, a compressor, a high pressure circuit, and a low pressure circuit than is fluidly connected to a contactor or a portion of a conducting a second regeneration during a second regenerating step or a segment for a first condition during a first conditioning step to create a vacuum and enable upgrading of some low pressure stream recovered from the sorbent contactor under sub ambient evacuation into stream at sufficient pressure partial pressure in third component to be used in first regenerating step or during a fraction of the first regenerating step. In a process embodiment, the process can be used to increase the pressure of the steam removed from the bed from a pressure range of about 0.3 to 0.7 Bara to about 0.8 to 1.2 Bara. The process can maximize the recovery of the steam during this step and a heated steam compression pump can be used to recycle some of the mid pressure steam.

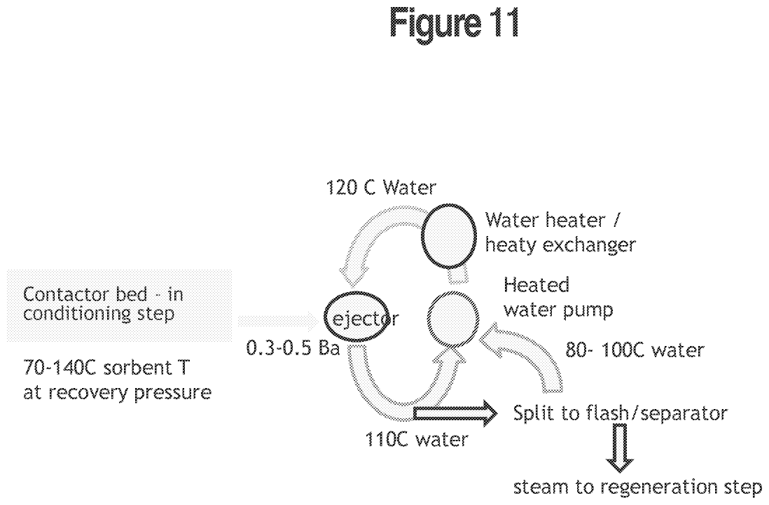

FIG. 11 illustrates an embodiment combination ejector compressor with a hot liquid loop than can be fluidly connected to a contactor or a portion of a conducting a second regeneration during a second regenerating step to create a vacuum to remove water from the sorbent and upgrade the recovered sub atmospheric steam into higher pressure steam or hot water than can be flashed to produced steam for a fraction of the first regenerating step. In an embodiment, flowing hot water through the ejector to create and pull a vacuum. Regenerating steam can be accomplished by flashing at least a portion of the water at a temperature above 100° C. in the ejector pump loop. Adding heat or heat make up is achieved by an extra water heater fluidly connected in the loop. The flash can operate near the point of use below atmospheric pressure which can be advantageous from a heat recovery prospective and integration with waste heat.

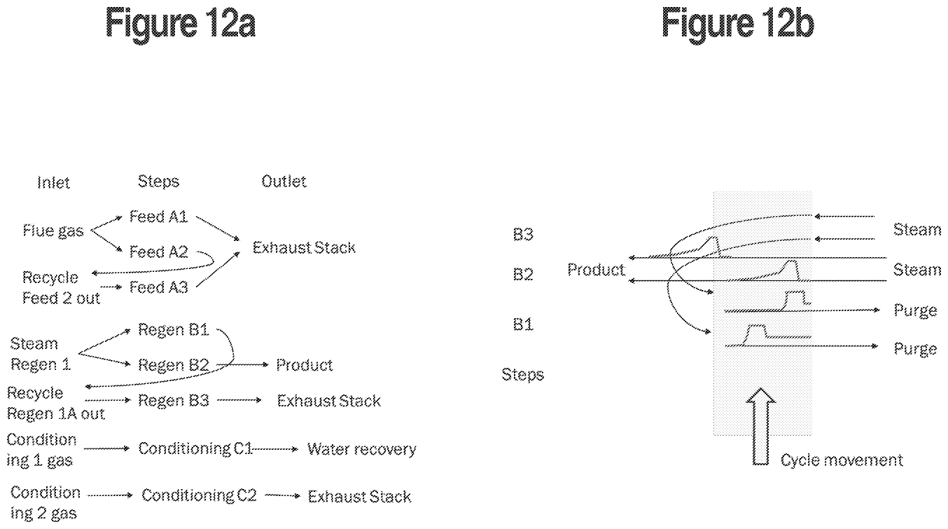

FIG. 12a provides a process flow diagram illustrating splitting of a feed step and regenerating steps into three sub-steps. This allows for switching between a single pass contact with the feed or regeneration stream or contact in series of the feed or regeneration stream through two contactors. The benefit of changing the fluid stream flow configuration during the sorption cycle is to maximize product recovery and product purity of the process. FIG. 12b illustrate on example of the implementation of the three sub-steps B1, B2, B3 on a moving bed or moving contactor system. The red plots on top of each flow direction arrows illustrate the concentration profile in first component in the flow direction of a sorbent bed or a contactor as function of process time and step. It should be noted that behind a first component peak in local concentration in the sorbent is a high concentration of third component pushing the first component in the flow direction. When reversing flow direction mid regeneration, the dead volume between the sorbent bed face and isolation valve is flushed with third component reducing the risk of dilution of the product by leftover undesirable gas component such as a second component.

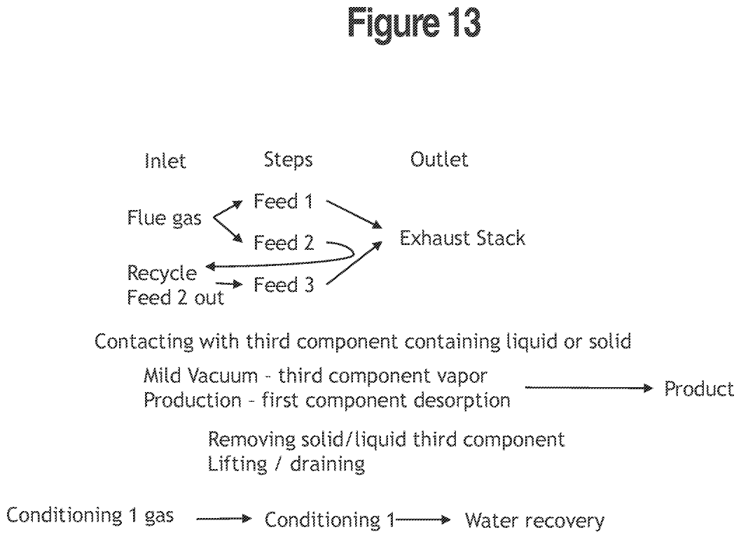

FIG. 13 provides a process flow diagram where part of the sorbent is immersed in a liquid containing the third component in association with a reduction of pressure. The feed steps and conditioning step stay the same as in FIG. 12a. In this case a vapor of third component is formed in situ at the pressure of the regenerating step. This does eliminate some energy losses from superheating the third component and transporting the fluid stream in a gas phase to the separation vessel. It also offers the opportunity to recover some of the heat generated by the adsorption of the third component on the sorbent.

In an embodiment of a system enabling the process described in the invention, a vessel containing the sorbent contactor is fluidly connected to an ejector on the ejector low pressure inlet side. The ejector is also connected to a motive stream on the ejector high pressure stream inlet side, the outlet of the ejector is fluidly connected to a compressor and with a split to a medium pressure steam reservoir. The outlet of the compressor is connected to a heat exchanger and a steam inlet before returning and connecting to the high pressure inlet side of the ejector.

Any sorptive separator or sorptive contactor described in any of the above-detailed embodiments can employ any suitable sorbent materials including but not limited to, for example, desiccant, activated carbon, graphite, carbon molecular sieve, activated alumina, molecular sieve, aluminophosphate, silicoaluminophosphate, zeolite adsorbent, ion exchanged zeolite, hydrophilic zeolite, hydrophobic zeolite, modified zeolite, natural zeolites, faujasite, clinoptilolite, mordenite, metal-exchanged silico-aluminophosphate, uni-polar resin, bi-polar resin, aromatic cross-linked polystyrenic matrix, brominated aromatic matrix, methacrylic ester copolymer, carbon fiber, carbon nanotube, nano-materials, metal salt adsorbent, perchlorate, oxalate, alkaline earth metal particle, ETS, CTS, metal oxide, supported alkali carbonates, alkali-promoted hydrotal cites, chemisorbent, amine, polyethylenimine doped silica (PEIDS) adsorbent, organo-metallic adsorbent, and metal organic framework adsorbent materials, and combinations thereof.

In an embodiment, a cyclic sorptive gas separation process for separating a component of a feed stream comprising at least a first component, and a second component, said sorptive gas separation process comprising:
(a) a feed or sorbing step comprising:
i. admitting said feed stream into a contactor having at least a first sorbent therein, for contacting said feed stream with said first sorbent,
ii. sorbing at least a portion of said first component onto said at least said first sorbent,
iii. producing a first product stream, at least partially depleted of said first component relative to said feed stream, and
iv. recovering said first product stream from said at least one contactor; and
(b) a regenerating step comprising:
i. admitting or feeding at least a first regeneration stream having a third component into said at least one contactor,
ii. sorbing or condensing a fraction of said third component into said at least one contactor
iii. desorbing a fraction of said at least first component sorbed onto said at least said first sorbent,
iv. recovering a second product stream from said at least one contactor,
wherein said regeneration step further comprises controlling a partial pressure of said third component in a first regeneration stream to a partial pressure threshold equal to or greater than 0.4 Bara for at least a of fraction of said regenerating step,
wherein said at least said first sorbent is one of: a metal organic framework (MOF) sorbent, a polyethylenimine doped silica (PEIDS) sorbent, an amine containing porous network polymer sorbent, an amine doped porous material sorbent, an amine doped MOF sorbent, a zeolite sorbent, an activated carbon, a doped activated carbon, a doped graphene, an alkali-doped or a rare earth doped porous inorganic sorbent.

In such an embodiment, the process can further comprising during step (a), controlling a temperature of said feed stream to a feed temperature threshold of equal to or less than 80° C.

Further still, the process can comprise, wherein during step (b), said contacting said first regeneration stream along said at least one contactor occurs over a first duration, and during step (a), said contacting said feed stream along said at least one contactor occurs over a second duration, and said first duration is equal to or less than 40% of said second duration.

In embodiments, the above process can further comprise during step (a), contacting said feed stream along said at least one contactor with a dose of said first component within a first component dose threshold range of 0.3 to 3 mmol of said first component for each gram of sorbent contained in said at least one contactor.

Further still, in embodiments, the process can further comprising during step (b), contacting said first regeneration stream along said at least one contactor with a dose of said third component within a third component dose threshold range of 1 to 6 mmol of said third component for each gram of said sorbent contained in said at least one contactor.

In another embodiment, the process can further comprise recovering said second product stream with a dose of said first component recovery within a first component dose recovery threshold range of 0.15 to 1.5 mmol of said first component for each gram of said sorbent contained in said at least one contactor, during step (b).

In another embodiment, subsequent to step (b), the process can further comprising step (c), reducing a partial pressure of said third component of a gas phase in said at least one contactor and recovering a third product stream from said at least one contactor.

In an alternate embodiment, step (c) can comprise reducing a pressure in said at least one contactor and recovering a third product stream from said at least one contactor.

Further still, in another alternate embodiment, step (c) can comprise admitting a condition stream into said at least one contactor, said condition stream having said third component and a third component partial pressure equal to or less than a third component partial pressure threshold of 50% of an equilibrium vapor pressure of said third component at a temperature of said at least said first sorbent at the end of step (b), flushing or sweeping said at least one contactor, and recovering a third product stream from said at least one contactor.

In such an alternate embodiment, the process can further comprise recovering said condition stream and said feed stream from a same source.

Further still, in such an alternate embodiment, the said condition stream can be a fraction of said feed stream.

Still, in an alternate to the embodiment, step (c) can be performed at a conditioning pressure within said at least one contactor and performing step (a) at a feed pressure within said at least one contactor, wherein said conditioning pressure is less than said feed pressure.

Further still, in an alternate of such an embodiment, the process can also comprise conditioning said condition stream by removing a portion of said third component from said condition stream, prior to contacting said condition stream along said at least one contactor.

In such an embodiment, the process can further comprise at least one of cooling and condensing said condition stream and removing said portion of said third component from said condition stream.

In an embodiment the process can further comprise contacting said condition stream with a second sorbent for selectively removing said portion of said third component from said condition stream, wherein said second sorbent differs from said first sorbent.

In an embodiment, the process can further still comprise contacting said condition stream with a second sorbent material for selectively removing said portion of said third component from said condition stream, wherein said second sorbent material is same as said second sorbent.

In an alternate embodiment, the process can comprise performing said sorptive gas separation process in equal to or less than 2 minutes and during step (b), said contacting said first regeneration stream along said at least one contactor comprising said at least said first sorbent is at a duration equal to or less than 15 seconds, preferably performing said sorptive gas separation process in equal to or less than 1 minute and during step (b) said contacting said first regeneration stream along said at least one contactor comprising said at least said first sorbent is at a duration equal to or less than 8 seconds, or more preferably performing said sorptive gas separation process in equal to or less than 30 seconds and during step (b) said contacting said first regeneration stream along said at least one contactor comprising said at least said first sorbent is at a duration equal to or less than 6 seconds.

Further still, the process can comprise residing a non-sorbed molecule of said feed stream in said at least one contactor for a residence duration of equal to or less than 5 seconds, preferably equal to or less than 2 seconds, or more preferably equal to or less than 1 second.

In embodiments, flowing said feed stream through said at least one contactor within a feed superficial velocity threshold range of 0.2 to 10 m/s.

Yet, in embodiment, the process can also comprise flowing at least one of the feed stream, first regeneration stream and condition stream through said at least one contactor within a feed superficial velocity threshold range further comprises a 1 to 30 m/s.

In embodiments, the process can also comprise providing said at least one contactor having a wetted surface area of equal to or greater than 1000 m2/m3, or preferably equal to or greater than 2000 m2/m3.

Further, embodiments can comprise providing said at least one contactor having a pressure drop during step (a) of equal to or less than 30 kPa, or preferably equal to or less than 10 kPa.

In embodiments, the process can further comprise providing said at least one contactor having a sorbent cycle capacity for sorption of said first component relative to a heat capacity of said at least one contactor in contact with said feed stream and/or said first regeneration stream of equal to or greater than 0.1 mmol/joule per kelvin.

In embodiments, the process can also comprise flooding or submersing said at least one contactor into a liquid and displacing a gas in one or more flow channels or voids of said at least one contactor, for increasing said fraction of said first component.

In embodiments, the process can also comprise reducing a pressure in said at least one contactor, flooding or submersing said at least one contactor in a liquid; and after said flooding or said submersing said at least one contactor in said liquid at least one of draining said liquid from and purging said at least one contactor.

In embodiments, the said at least one contactor further comprises a first contactor and a second contactor, and further comprises during at least a fraction of step (a) in said first contactor, contacting said feed stream with said first contactor, recovering said first product stream from said first contactor and admitting said first product stream from said first contactor as a feed stream into said second contactor. In such an embodiment, the process further comprises during at least a fraction of step (a) in said second contactor, contacting said feed stream in said second contactor, and recovering said first product stream from said second contactor.

In alternate embodiments, the process further comprises providing a plurality of said at least one contactor; and performing at least at least one of step (a), step (b) and step (c) concurrently or in parallel in said plurality of said at least one contactor, or performing at least one of step (a), step (b) and step (c) by staggering or alternating step (a), step (b) and step (c) in said plurality of said at least one contactor.

In another alternate embodiment, wherein said at least one contactor further comprises a first contactor, a second contactor and a third contactor fluidly connected in series, the process can further comprise during at least a fraction of a first step (a) in said first contactor, contacting said feed stream with said first contactor, recovering said first product stream from said first and admitting said first product stream from said first contactor as a feed stream into said second contactor, while during at least a fraction of a second step (a) in said second contactor, contacting said feed stream in said second contactor, recovering said first product stream from said second contactor and admitting said first product stream from said second contactor as a feed stream into said third contactor.

In embodiments, the process can further comprise step (b2) immediately after step (b), reducing a pressure in said at least one contactor, contacting a second regeneration stream along said at least said first sorbent, desorbing said first component and said third component from said at least said first sorbent; and recovering said first component and third component from said at least one contactor.

In such an embodiment, wherein during step (b2), the said pressure in said at least one contactor is in a range of 0.1 to 0.4 Bara.

In embodiments, the process can further comprise condensing and recycling said third component from at least one of said feed stream, said first product stream, and said third product stream, and using said third component for said first regeneration stream, wherein said third component is water.

In another alternate embodiment the process can further comprise removing at least a portion of said third component from said third product stream forming a conditioned third product stream, and recycling said conditioned third product stream as at least a portion of said first regeneration stream.

In such an embodiment, the said second regeneration stream has an oxygen concentration less than an oxygen concentration of at least one of said feed stream or an atmospheric air.

Further still, in such embodiments, a pressure of said feed stream is in a range of 1 to 5 Bara.

In another alternate embodiment, the process can further comprise during step (c) admitting a motive fluid into an ejector and inducing a vacuum in said at least one contactor for recovering said third product stream from said at least one contactor.

In such embodiments, the said motive stream is a pressurized gas comprising said third component, said motive stream is at a pressure greater than 1 Bara, or preferable greater than 2 Bara, and having a concentration of said third component of greater than 50%, preferably greater than 90%, or more preferable greater than 98%.

Further still, in such embodiments, the said motive stream is a liquid at a temperature at which a saturated partial pressure of said third component is greater than 0.4 Bara, or preferably greater than 1 Bara.

In embodiments, said first component is carbon dioxide, said second component is nitrogen and said third component is water.

In a second broad aspect of the invention, a cyclic sorptive gas separation process for separating a component of a feed stream comprising at least a first component and a second component, can comprise:
(a1) a first feed or sorbing step comprising:
passing a first feed stream along at least one contactor comprising at least one sorbent, sorbing said first component of said first feed stream onto said at least one sorbent, producing a first fraction of first product stream partially depleted of said first component relative to said feed stream, and recovering said first fraction of first product stream from said at least one contactor;
(a2) a second feed or a second sorbing step comprising:
passing a second feed stream along said at least one contactor comprising said at least one sorbent, sorbing said first component of said second feed stream onto said at least one sorbent, producing a second fraction of first product stream partially depleted of first component relative to said second feed stream, and recovering second fraction of first product stream from said at least one contactor;
(b1) a first regenerating step comprising:
contacting a first regeneration stream having at least said third component with said at least one contactor comprising said at least one sorbent, sorbing or condensing a fraction of said third component from said first regeneration stream onto said at least one sorbent and desorbing said first component, and recovering a first fraction of second product stream from said at least one contactor;
(b2) a second regenerating step comprising:
controlling a partial pressure of said third component of a second regeneration stream to a third component partial pressure threshold of equal to or greater than 0.4 Bara for at least of fraction of step (b2), contacting said second regeneration stream with said at least one contactor comprising said at least one sorbent, sorbing or condensing a fraction of said third component from said second regeneration stream onto said at least one sorbent and desorbing said first component, and recovering a second fraction of second product stream from said at least one contactor;
(c1) a first conditioning step comprising at least one of:
reducing a partial pressure of said third component or a relative humidity of a gas phase contained in said at least one contactor and recovering a first fraction of third product stream from said at least one contactor, reducing a pressure of a gas phase contained in said at least one contactor and recovering a first fraction of third product stream from said at least one contactor, and admitting a first condition stream into said at least one contactor, said first condition stream having said third component and a third component partial pressure of equal to or less than a third component partial pressure threshold of 50% of an equilibrium vapor pressure of said third component at a temperature of said at least one sorbent at the end of step (b), flushing or sweeping said at least one contactor and recovering a first fraction of third product stream from said at least one contactor; and
(c2) a second condition step comprising at least one of:
reducing a partial pressure of said third component or a relative humidity of a gas phase contained in said at least one contactor and recovering a second fraction of third product stream from said at least one contactor, reducing a pressure of a gas phase contained in said at least one contactor and recovering a second fraction of third product stream from said at least one contactor, and admitting a second condition stream into said at least one contactor, said second condition stream having said third component and a third component partial pressure threshold of equal to or less than a third component partial pressure threshold of 50% of an equilibrium vapor pressure of said third component at a temperature of said at least one sorbent at the end of step (b), flushing or sweeping said at least one contactor and recovering a second fraction of third product stream from said at least one contactor. In embodiments, the said at least one sorbent is one of: a metal organic framework (MOF) sorbent, a polyethylenimine doped silica (PEIDS) sorbent, an amine containing porous network polymer sorbent, an amine doped porous material sorbent, an amine doped MOF sorbent, a zeolite sorbent, an activated carbon, a doped activated carbon, a doped graphene, an alkali-doped or rare earth doped porous inorganic sorbent, and during step (a1) and step (a2), or step (b1) and step (b2), or step (c1) and step (c2) are conducted having at least one of different pressures, different temperatures or with different process stream compositions between each step.

In such an embodiment, wherein during step (a1) a partial pressure of said third component in said first feed stream is less than a partial pressure of said third component in said second feed stream during step (a2).

Further still, in an alternate embodiment, during step (a1) a pressure of said first feed stream is at a first feed stream pressure and during step (a2) a pressure of said second feed stream is at a second feed stream pressure, wherein said first feed stream pressure is less than said second feed stream pressure.

In embodiments, the process can further comprise during step (a1) evacuating said at least one contactor with a pump for reducing a pressure within said at least one contactor and said first feed stream to said first feed stream pressure.

In embodiments, the process can further comprise during step (a2) compressing said second feed stream with a compressor or a pump for increasing said pressure of said second feed stream to said second feed stream pressure.

In embodiments, during step (b1) said first regeneration stream is at a pressure in a pressure range of 0.1 to 0.4 Bara and having a first component or a third component for flushing at least said second component in a void space of said at least one contactor.

Alternatively, in embodiments, during step (b1) said first regeneration stream having a concentration of said third component within a third component concentration threshold range of greater than 20 volume % and less than 90 volume %.

In embodiments, the process further comprises during step (c1) recovering said first fraction of third product stream and during step (b1) using said first fraction of third product stream as at least a portion of said first regeneration stream.

In such an embodiment, during step (c1), the process can further comprise admitting a motive fluid having said third component into an ejector and inducing a vacuum for recovering said first fraction of third product stream from said at least one contactor. In embodiments, the said motive fluid is at a pressure equal to or greater than a motive fluid pressure threshold of 2 Bara.

In another alternate embodiment, the process further comprises recovering at least one condensate stream from at least one of said first fraction of first product stream, said second fraction of first product stream, said first fraction of second product stream, said second fraction of second product stream, said first fraction of third product stream, or said second fraction of third product stream; and during step (c1) admitting said at least one condensate stream as a motive fluid into an ejector and inducing a vacuum in said at least one contactor, for assisting in desorbing said third component.

In such an embodiment, the process further comprises during step (c1) recovering said first fraction of third product stream and during step (b1) using said first fraction of third product stream as at least a portion of said first regeneration stream.

In an alternate embodiment, the process further comprises during step (c1) recovering said first fraction of third product stream having a first partial pressure of said third component and during step (c2) recovering said second fraction of third product stream having a second partial pressure of said third component, wherein said first partial pressure of said third component is greater than said second partial pressure of said third component.

In other embodiments, the process can further comprise during step (c1) recovering said first fraction of third product stream and during step (b1) using said first fraction of said third product stream as at least a portion of said first regeneration stream.

In embodiments, the process can further comprise controlling a pressure of said first fraction of said third product stream during step (c1) by a pump, an ejector, a condensing heat exchanger, recovering said third component from said first fraction of said third product stream, and admitting said third component recovered from said first fraction of said third product stream as at least a portion of said first regeneration stream in step (b1), or as at least a portion of said second regeneration stream in (b2), or as at least a portion of said first regeneration stream in step (b1), and as at least a portion of said second regeneration stream in (b2).

In alternate embodiments, the process can further comprise after step (a2) and before step (b1) flooding or submersing said at least one contactor into a liquid and displacing a gas in one or more flow channels or voids of said at least one contactor, for increasing said fraction of said first component recovered from said at least one contactor or said second product stream during step (b1).

In alternate embodiments, the process can further comprise before step (b1), reducing a pressure in said at least one contactor, flooding or submersing said at least one contactor in a liquid; and after said flooding or said submersing said at least one contactor in said liquid at least one of draining said liquid from and purging said at least one contactor.

In embodiments, the process can further comprise providing a plurality of said at least one contactor; and performing at least at least one of step (a1), step (b1) and step (c1) concurrently or in parallel in said plurality of said at least one contactor, or performing at least one of step (a1), step (b1) and step (c1) by staggering or alternating step (a1), step (b1) and step (c1) in said plurality of said at least one contactor.

In alternate embodiments, wherein said at least one contactor comprises a first contactor, a second contactor and a third contactor fluidly connected in series, said process can further comprise during at least a fraction of step (a1) in said first contactor, contacting said feed stream with said first contactor, recovering said first product stream from said first and admitting said first product stream from said first contactor as a feed stream into said second contactor, while during at least a fraction of step (a2) in said second contactor, contacting said feed stream in said second contactor, recovering said first product stream from said second contactor and admitting said first product stream from said second contactor as a feed stream into said third contactor.

In alternate embodiments, wherein said at least one contactor comprises a first contactor, and a second contactor fluidly connected in series further comprising, during at least a fraction of step (b1) in said first contactor contacting said first regeneration stream with said first, recovering a first fraction of said second product stream from said first contactor and contacting said first fraction of said second product stream from said first contactor as said first regeneration stream into said second contactor; and during at least a fraction step (b2) contacting said first regeneration stream in said second contactor, recovering a second fraction of said second product stream from said second contactor.

In such an embodiment, wherein said at least one contactor further comprise a third contactor fluidly connected in series to said second contactor, the process further comprising step (b3) immediately after step (b2) and during at least a fraction of a third step (b3) contacting said second fraction of said second product stream from said second contactor as a first regeneration stream into said third contactor.

In the above embodiment, the process can further comprise during steps (a1) and (b1) fluidly connecting said plurality of said at least one contactor in series, and during at least a portion of step (c1) fluidly connecting said plurality of said at least one contactor in parallel.

In alternate embodiments, wherein said at least one contactor further comprise a first contactor, a second contactor, and a third contactor, said process can further comprise a step (b3) immediately after step (b2) comprising performing one of step (b1), step (b2) and a step (b3) in said first contactor, said second contactor, and said third contactor, where step (b1), step (b2) and step (b3) are performed in parallel, during step (b3) contacting a third regeneration stream with said at least one sorbent in one of said first contactor, said second contactor, and said third contactor, and recovering a third fraction of said second product stream from one of said first contactor, said second contactor, or said third contactor, during step (b1) using said third fraction of said second product stream recovered in step (b3) as at least a portion of said first regeneration stream, contacting said first regeneration stream with said at least one sorbent in one of said first contactor, said second contactor, and said third contactor, and recovering said first fraction of said second product stream from one of said first contactor, said second contactor, or said third contactor, and during step (b2) contacting said second regeneration stream with said at least one sorbent in one of said first contactor, said second contactor, and said third contactor, and recovering said second fraction of said second product stream as a purified first component stream, wherein step (b1), step (b2) and step (b3) are performed sequentially in said first contactor, said second contactor, and said third contactor.

In alternate embodiments, the process can further comprise during step (a1) passing said first feed stream having and a first partial pressure of said first component and during step (a2) passing said second feed stream having a second partial pressure of said first component, wherein said first concentration is less than said second concentration and said first partial pressure is less than said second partial pressure.

In such an embodiment, said first feed stream comprise an air stream, said second feed stream comprise a flue gas stream, said first component is carbon dioxide and said third component is water.

Further still, in embodiments, wherein said at least one contactor further comprises a first contactor, and a second contactor, said process further comprises performing in said first contactor step (a1), step (a2), step (b) or steps (b1) and (b2), step (c) or steps (c1) and (c2), and performing in said second contactor step (a2), step (b) or steps (b1) and (b2), step (c) or steps (c1) and (c2).

In embodiments, the process can further comprise a step (b3) immediately after step (b2) which can comprise reducing a pressure in said at least one contactor, contacting a second regeneration stream or a third regeneration stream along said at least one sorbent, desorbing said first component and said third component from said at least one sorbent, and recovering said first component and third component from said at least one contactor.

In embodiments, during step (b3), the said pressure in said at least one contactor is in a range of 0.1 to 0.4 Bara.

In embodiments, the said first component is carbon dioxide, said second component is nitrogen and said third component is water.

In embodiments, the process can further comprise performing said sorptive gas separation process in equal to or less than 2 minutes and during step (b) said contacting said first regeneration stream along said at least one contactor comprising said at least one sorbent is at a duration equal to or less than 15 seconds, or preferably equal to or less than 10 seconds; preferably performing said sorptive gas separation process in equal to or less than 1 minute and during step (b) said contacting said first regeneration stream along said at least one contactor comprising said at least one sorbent is at a duration equal to or less than 8 seconds; or more preferably performing said sorptive gas separation process in equal to or less than 30 seconds and during step (b) said contacting said first regeneration stream along said at least one contactor comprising said at least one sorbent is at a duration equal to or less than 6 seconds.

In an alternate broad embodiment, a cyclic sorptive gas separation process for separating a component of a feed stream comprising at least a first component and a second component, comprises:
(a) contacting said feed stream along at least one contactor comprising at least one sorbent;
(b) sorbing said first component of said feed stream onto said at least one sorbent;
(c) producing a first product stream partially depleted of said first component relative to said feed stream;
(d) recovering said first product stream from said at least one contactor;
(e) producing a first regeneration stream having a third component within a vessel fluidly connected to said at least one contactor or within said at least one contactor, said first regeneration stream having partial pressure of said third component equal to or greater than a third component partial pressure threshold of 0.4 Bara during at least a fraction of step (b);
(f) contacting said first regeneration stream with said at least one sorbent in said least one contactor;
(g) sorbing or condensing a fraction of said third component of said first regeneration stream onto said at least one sorbent and desorbing a fraction of said first component from said at least one sorbent, and
(h) recovering a second product stream from said at least one contactor.

In embodiments, the said at least one sorbent is one of: a metal organic framework (MOF) sorbent, a polyethylenimine doped silica (PEIDS) sorbent, an amine containing porous network polymer sorbent, an amine doped porous material sorbent, an amine doped MOF sorbent, a zeolite sorbent, an activated carbon, a doped activated carbon, a doped graphene, an alkali-doped or rare earth doped porous inorganic sorbent.

In an embodiment, the process can further comprise during step (b) contacting said first regeneration stream in said at least one contactor at a pressure within said at least one contactor between a pressure threshold range of 0.4 Bara to 0.95 Bara, wherein said first regeneration stream is in a liquid phase at a temperature equal to or greater than an evaporation temperature of said third component within said at least one contactor during step (b).

Alternately, in another embodiment, the process during step (b), can comprise generating a heat of adsorption from sorbing said fraction of said third component of said first regeneration stream onto said at least one sorbent and transferring at least a portion of said heat of adsorption to said third component in said liquid phase by at least one of thermal conduction and thermal convection.

In embodiments, the process further comprises providing said at least one contactor having a wetted surface of said at least one contactor which repels water in a liquid phase, for preventing liquid water from occupying a pore volume and/or a flow channel of said at least one contactor.

Still, in embodiments, the process can further comprise after step (a) and before step (b) flooding or submersing said at least one contactor into a liquid and displacing a gas in one or more flow channels or voids of said at least one contactor, for increasing said fraction of said first component recovered from said at least one contactor or said second product stream during step (b).

Further still, in alternate embodiments, the process can further comprise before step (b), reducing a pressure in said at least one contactor, flooding or submersing said at least one contactor in a liquid; and after said flooding or said submersing said at least one contactor in said liquid at least one of draining said liquid from and purging said at least one contactor.

In an alternate embodiment, wherein said at least one contactor comprises a first contactor and a second contactor, said process can further comprise, during at least a fraction of step (a) in said first contactor, contacting said feed stream with said first contactor, recovering said first product stream from said first contactor and admitting said first product stream from said first contactor as a feed stream into said second contactor, while during at least a fraction of step (a) in said second contactor, contacting said feed stream in said second contactor, recovering said first product stream from said second contactor and directing said first product stream from said second contactor as a feed stream.

In embodiments, the process can also further comprise step (b2) immediately after step (b), comprising reducing a pressure in said at least one contactor, contacting a second regeneration stream along said at least one sorbent, desorbing said first component and said third component from said at least one sorbent, and recovering said first component and third component from said at least one contactor.

In such an embodiment, the said pressure in said at least one contactor is in a range of 0.1 to 0.4 Bara.

In embodiments, the process can further comprise condensing and recycling said third component from at least one of said feed stream, said first product stream, and said third product stream, and using said third component for at least one of: said first regeneration stream, and said second regeneration stream, wherein said third component is water.

In embodiments, the said first component is carbon dioxide and said third component is water.

In such embodiments, a pressure of said feed stream is in a range of 1 to 5 Bara.

In embodiments, the process can also comprise performing said sorptive gas separation process in equal to or less than 2 minutes and during step (b) said contacting said first regeneration stream along said at least one contactor comprising said at least one sorbent is at a duration equal to or less than 15 seconds, or preferably equal to or less than 10 seconds; preferably performing said sorptive gas separation process in equal to or less than 1 minute and during step (b) said contacting said first regeneration stream along said at least one contactor comprising said at least one sorbent is at a duration equal to or less than 8 seconds; or more preferably performing said sorptive gas separation process in equal to or less than 30 seconds and during step (b) said contacting said first regeneration stream along said at least one contactor comprising said at least one sorbent is at a duration equal to or less than 6 seconds.

What is claimed is:

1. A cyclic sorptive gas separation process for separating a component of a feed stream comprising at least a first component, and a second component, said sorptive gas separation process comprising:
(a) a feed or sorbing step comprising:
i. admitting said feed stream into a contactor having at least a first sorbent therein, for contacting said feed stream with said first sorbent,
ii. sorbing at least a portion of said first component onto said at least said first sorbent,
iii. producing a first product stream, at least partially depleted of said first component relative to said feed stream, and
iv. recovering said first product stream from said at least one contactor; and
(b) a regenerating step comprising:
i. admitting or feeding at least a first regeneration stream having a third component into said at least one contactor,
ii. sorbing or condensing a fraction of said third component into said at least one contactor
iii. desorbing a fraction of the at least first component sorbed onto said at least said first sorbent,
iv. recovering a second product stream from said at least one contactor,
wherein said regeneration step further comprises controlling a partial pressure of said third component in a first regeneration stream to a partial pressure threshold equal to or greater than 0.4 Bara for at least a of fraction of said regenerating step,
wherein said at least said first sorbent is one of: a metal organic framework (MOF) sorbent, a polyethylenimine doped silica (PEIDS) sorbent, an amine containing porous network polymer sorbent, an amine doped porous material sorbent, an amine doped MOF sorbent, a zeolite sorbent, an activated carbon, a doped activated carbon, a doped graphene, an alkali-doped or a rare earth doped porous inorganic sorbent.

2. The process of claim 1, further comprising during step (a), controlling a temperature of said feed stream to a feed temperature threshold of equal to or less than 80° C.

3. The process of claim 1 or 2, wherein during step (b), said contacting said first regeneration stream along said at least one contactor occurs over a first duration, and during step (a), said contacting said feed stream along said at least one contactor occurs over a second duration, and said first duration is equal to or less than 40% of said second duration.

4. The process of any one of claim 1, 2, or 3, further comprising during step (a), contacting said feed stream along said at least one contactor with a dose of said first component within a first component dose threshold range of 0.3 to 3 mmol of said first component for each gram of sorbent contained in said at least one contactor.

5. The process of any one of claims 1 to 4, further comprising during step (b), contacting said first regeneration stream along said at least one contactor with a dose of said third component within a third component dose threshold range of 1 to 6 mmol of said third component for each gram of said sorbent contained in said at least one contactor.

6. The process of any one of claims 1 to 5, further comprising during step (b), recovering said second product stream with a dose of said first component recovery within a first component dose recovery threshold range of 0.15 to 1.5 mmol of said first component for each gram of said sorbent contained in said at least one contactor.

7. The process of any one of claims 1 to 6, subsequent to step (b), further comprising a step (c), reducing a partial pressure of said third component of a gas phase in said at least one contactor and recovering a third product stream from said at least one contactor.

8. The process of any one of claims 1 to 6, subsequent to step (b), further comprising a step (c), reducing a pressure in said at least one contactor and recovering a third product stream from said at least one contactor.

9. The process of any one of claims 1 to 6, subsequent to step (b), further comprising a step (c), admitting a condition stream into said at least one contactor, said condition stream having said third component and a third component partial pressure equal to or less than a third component partial pressure threshold of 50% of an equilibrium vapor pressure of said third component at a temperature of said at least said first sorbent at the end of step (b), flushing or sweeping said at least one contactor, and recovering a third product stream from said at least one contactor.

10. The process of claim 9, further comprising recovering said condition stream and said feed stream from a same source.

11. The process of claim 10, wherein said condition stream is a fraction of said feed stream.

12. The process of claim 9, further comprising performing said step (c) at a conditioning pressure within said at least one contactor and performing step (a) at a feed pressure within said at least one contactor, wherein said conditioning pressure is less than said feed pressure.

13. The process of claim 9, further comprising conditioning said condition stream by removing a portion of said third component from said condition stream, prior to contacting said condition stream along said at least one contactor.

14. The process of claim 13, further comprising at least one of cooling and condensing said condition stream and removing said portion of said third component from said condition stream.

15. The process of claim 13, further comprising contacting said condition stream with a second sorbent for selectively removing said portion of said third component from said condition stream, wherein said second sorbent differs from said first sorbent.

16. The process of claim 13, further comprising contacting said condition stream with a second sorbent for selectively removing said portion of said third component from said condition stream, wherein said second sorbent is same as said first sorbent.

17. The process of any one of claims 1 to 16, further comprising performing said sorptive gas separation process in equal to or less than 2 minutes and during step (b), said contacting said first regeneration stream along said at least one contactor comprising said at least said first sorbent is at a duration equal to or less than seconds, preferably performing said sorptive gas separation process in equal to or less than 1 minute and during step (b) said contacting said first regeneration stream along said at least one contactor comprising said at least said first sorbent is at a duration equal to or less than 8 seconds, or more preferably performing said sorptive gas separation process in equal to or less than 30 seconds and during step (b) said contacting said first regeneration stream along said at least one contactor comprising said at least said first sorbent is at a duration equal to or less than 6 seconds.

18. The process of any one of claims 1 to 16, further comprising residing a non-sorbed molecule of said feed stream in said at least one contactor for a residence duration of equal to or less than 5 seconds, preferably equal to or less than 2 seconds, or more preferably equal to or less than 1 second.

19. The process of any one of claims 1 to 16, further comprising flowing said feed stream through said at least one contactor within a feed superficial velocity threshold range of 0.2 to 10 m/s.

20. The process of any one of claims 1 to 16, further comprising flowing at least one of the feed stream, first regeneration stream and condition stream through said at least one contactor within a feed superficial velocity threshold range further comprises a 1 to 30 m/s.

21. The process of any one of claims 1 to 20, further comprising providing said at least one contactor having a wetted surface area of equal to or greater than 1000 m²/m³, or preferably equal to or greater than 2000 m²/m³.

22. The process of any one of claims 1 to 21, further comprising providing said at least one contactor having a pressure drop during step (a) of equal to or less than 30 kPa, or preferably equal to or less than 10 kPa.

23. The process of any one of claims 1 to 22, further comprising providing said at least one contactor having a sorbent cycle capacity for sorption of said first component relative to a heat capacity of said at least one contactor in contact with said feed stream and/or said first regeneration stream of equal to or greater than 0.1 mmol/joule per kelvin.

24. The process of any one of claims 1 to 23, further comprising flooding or submersing said at least one contactor into a liquid and displacing a gas in one or more flow channels or voids of said at least one contactor, for increasing said fraction of said first component.

25. The process of any one of claims 1 to 23, further comprising reducing a pressure in said at least one contactor, flooding or submersing said at least one contactor in a liquid; and after said flooding or said submersing said at least one contactor in said liquid at least one of draining said liquid from and purging said at least one contactor.

26. The process of claim 1, wherein said at least one contactor further comprises a first contactor and a second contactor, further comprising:
during at least a fraction of step (a) in said first contactor:
contacting said feed stream with said first contactor,
recovering said first product stream from said first contactor and
admitting said first product stream from said first contactor as a feed stream into said second contactor; and
during at least a fraction of step (a) in said second contactor:
contacting said feed stream in said second contactor, and
recovering said first product stream from said second contactor.

27. The process of claim 7, 8, or 9, further comprising providing a plurality of said at least one contactor; and performing at least at least one of step (a), step (b) and step (c) concurrently or in parallel in said plurality of said at least one contactor, or performing at least one of step (a), step (b) and step (c) by staggering or alternating step (a), step (b) and step (c) in said plurality of said at least one contactor.

28. The process of claim 7, 8, or 9, wherein said at least one contactor further comprises a first contactor, a second contactor and a third contactor fluidly connected in series, the process further comprising:
during at least a fraction of a first step (a) in said first contactor,
contacting said feed stream with said first contactor,
recovering said first product stream from said first and
admitting said first product stream from said first contactor as a feed stream into said second contactor; and
during at least a fraction of a second step (a) in said second contactor,
contacting said feed stream in said second contactor,
recovering said first product stream from said second contactor and
admitting said first product stream from said second contactor as a feed stream into said third contactor.

29. The process any one of claims 1 to 28, further comprising step (b2) immediately after step (b):
reducing a pressure in said at least one contactor;
contacting a second regeneration stream along said at least said first sorbent;
desorbing said first component and said third component from said at least said first sorbent; and
recovering said first component and third component from said at least one contactor.

30. The process of claim 29, wherein during step (b2), said pressure in said at least one contactor is in a range of 0.1 to 0.4 Bara.

31. The process any one of claims 1 to 30, further comprising:
condensing and recycling said third component from at least one of said feed stream, said first product stream, and said third product stream; and
using said third component for said first regeneration stream, wherein said third component is water.

32. The process of claim 7, 8, or 9, further comprising removing at least a portion of said third component from said third product stream forming a conditioned third product stream, and recycling said conditioned third product stream as at least a portion of said first regeneration stream.

33. The process of claim 29, wherein said second regeneration stream has an oxygen concentration less than an oxygen concentration of at least one of said feed stream or an atmospheric air.

34. The process of any one of claims 1 to 33 wherein a pressure of said feed stream is in a range of 1 to 5 Bara.

35. The process of claim 7, 8, or 9, further comprising during step (c) admitting a motive fluid into an ejector and inducing a vacuum in said at least one contactor for recovering said third product stream from said at least one contactor.

36. The process of claim 35, wherein said motive stream is a pressurized gas comprising said third component, said motive stream is at a pressure greater than 1 Bara, or preferable greater than 2 Bara, and having a concentration of said third component of greater than 50%, preferably greater than 90%, or more preferable greater than 98%.

37. The process of 35, wherein said motive stream is a liquid at a temperature at which a saturated partial pressure of said third component is greater than 0.4 Bara, or preferably greater than 1 Bara.

38. The process of any one of claims 1 to 37, wherein said first component is carbon dioxide, said second component is nitrogen and said third component is water.

39. A cyclic sorptive gas separation process for separating a component of a feed stream comprising at least a first component and a second component, said sorptive gas separation process comprising:
(a1) a first feed or sorbing step comprising:
passing a first feed stream along at least one contactor comprising at least one sorbent;
sorbing said first component of said first feed stream onto said at least one sorbent;
producing a first fraction of first product stream partially depleted of said first component relative to said feed stream, and
recovering said first fraction of first product stream from said at least one contactor;
(a2) a second feed or a second sorbing step comprising:
passing a second feed stream along said at least one contactor comprising said at least one sorbent;
sorbing said first component of said second feed stream onto said at least one sorbent;
producing a second fraction of first product stream partially depleted of first component relative to said second feed stream, and
recovering second fraction of first product stream from said at least one contactor;
(b1) a first regenerating step comprising:
contacting a first regeneration stream having at least said third component with said at least one contactor comprising said at least one sorbent;
sorbing or condensing a fraction of said third component from said first regeneration stream onto said at least one sorbent and desorbing said first component, and
recovering a first fraction of second product stream from said at least one contactor;
(b2) a second regenerating step comprising:
controlling a partial pressure of said third component of a second regeneration stream to a third component partial pressure threshold of equal to or greater than 0.4 Bara for at least of fraction of step (b2);
contacting said second regeneration stream with said at least one contactor comprising said at least one sorbent;
sorbing or condensing a fraction of said third component from said second regeneration stream onto said at least one sorbent and desorbing said first component,
recovering a second fraction of second product stream from said at least one contactor;
(c1) a first conditioning step comprising at least one of:
i. reducing a partial pressure of said third component or a relative humidity of a gas phase contained in said at least one contactor and recovering a first fraction of third product stream from said at least one contactor,
ii. reducing a pressure of a gas phase contained in said at least one contactor and recovering a first fraction of third product stream from said at least one contactor, and
iii. admitting a first condition stream into said at least one contactor, said first condition stream having said third component and a third component partial pressure of equal to or less than a third component partial pressure threshold of 50% of an equilibrium vapor pressure of said third component at a temperature of said at least one sorbent at the end of step (b), flushing or sweeping said at least one contactor and recovering a first fraction of third product stream from said at least one contactor;
(c2) a second condition step comprising at least one of:
i. reducing a partial pressure of said third component or a relative humidity of a gas phase contained in said at least one contactor and recovering a second fraction of third product stream from said at least one contactor,
ii. reducing a pressure of a gas phase contained in said at least one contactor and recovering a second fraction of third product stream from said at least one contactor, and
iii. admitting a second condition stream into said at least one contactor, said second condition stream having said third component and a third component partial pressure threshold of equal to or less than a third component partial pressure threshold of 50% of an equilibrium vapor pressure of said third component at a temperature of said at least one sorbent at the end of step (b), flushing or sweeping said at least one contactor and recovering a second fraction of third product stream from said at least one contactor,
wherein said at least one sorbent is one of: a metal organic framework (MOF) sorbent, a polyethylenimine doped silica (PEIDS) sorbent, an amine containing porous network polymer sorbent, an amine doped porous material sorbent, an amine doped MOF sorbent, a zeolite sorbent, an activated carbon, a doped activated carbon, a doped graphene, an alkali-doped or rare earth doped porous inorganic sorbent, and
wherein during step (a1) and step (a2), or step (b1) and step (b2), or step (c1) and step (c2) are conducted having at least one of different pressures, different temperatures or with different process stream compositions between each step.

40. The process of claim 39, wherein during step (a1) a partial pressure of said third component in said first feed stream is less than a partial pressure of said third component in said second feed stream during step (a2).

41. The process of claim 39, wherein during step (a1) a pressure of said first feed stream is at a first feed stream pressure and during step (a2) a pressure of said second feed stream is at a second feed stream pressure, wherein said first feed stream pressure is less than said second feed stream pressure.

42. The process of claim 41, further comprising during step (a1) evacuating said at least one contactor with a pump for reducing a pressure within said at least one contactor and said first feed stream to said first feed stream pressure.

43. The process of claim 41 or 42, further comprising during step (a2) compressing said second feed stream with a compressor or a pump for increasing said pressure of said second feed stream to said second feed stream pressure.

44. The process of any one of claims 39 to 43, wherein during step (b1) said first regeneration stream is at a pressure in a pressure range of 0.1 to 0.4 Bara and having a first component or a third component for flushing at least said second component in a void space of said at least one contactor.

45. The process of any one of claims 39 to 44, wherein during step (b1) said first regeneration stream having a concentration of said third component within a third component concentration threshold range of greater than 20 volume % and less than 90 volume %.

46. The process of any one of claims 39 to 45, further comprising during step (c1) recovering said first fraction of third product stream and during step (b1) using said first fraction of third product stream as at least a portion of said first regeneration stream.

47. The process of claim 46, further comprising during step (c1) admitting a motive fluid having said third component into an ejector and inducing a vacuum for recovering said first fraction of third product stream from said at least one contactor.

48. The process of claim 47, wherein said motive fluid is at a pressure equal to or greater than a motive fluid pressure threshold of 2 Bara.

49. The process of claim 46, 47 or 48, further comprising recovering at least one condensate stream from at least one of said first fraction of first product stream, said second fraction of first product stream, said first fraction of second product stream, said second fraction of second product stream, said first fraction of third product stream, or said second fraction of third product stream; and during step (c1) admitting said at least one condensate stream as a motive fluid into an ejector and inducing a vacuum in said at least one contactor, for assisting in desorbing said third component.

50. The process of claim 45, further comprising during step (c1) recovering said first fraction of third product stream and during step (b1) using said first fraction of third product stream as at least a portion of said first regeneration stream.

51. The process of claim 39, further comprising during step (c1) recovering said first fraction of third product stream having a first partial pressure of said third component and during step (c2) recovering said second fraction of third product stream having a second partial pressure of said third component, wherein said first partial pressure of said third component is greater than said second partial pressure of said third component.

52. The process of any one of claims 39 to 51, further comprising during step (c1) recovering said first fraction of third product stream and during step (b1) using said first fraction of said third product stream as at least a portion of said first regeneration stream.

53. The process of any one of claims 39 to 52, further comprising:
controlling a pressure of said first fraction of said third product stream during step (c1) by a pump, an ejector, a condensing heat exchanger;
recovering said third component from said first fraction of said third product stream, and
admitting said third component recovered from said first fraction of said third product stream as at least a portion of said first regeneration stream in step (b1), or as at least a portion of said second regeneration stream in (b2), or as at least a portion of said first regeneration stream in step (b1), and as at least a portion of said second regeneration stream in (b2).

54. The process of any one of claims 39 to 53, further comprising after step (a2) and before step (b1) flooding or submersing said at least one contactor into a liquid and displacing a gas in one or more flow channels or voids of said at least one contactor, for increasing said fraction of said first component recovered from said at least one contactor or said second product stream during step (b1).

55. The process of any one of claims 39 to 54, further comprising before step (b1), reducing a pressure in said at least one contactor, flooding or submersing said at least one contactor in a liquid; and after said flooding or said submersing said at least one contactor in said liquid at least one of draining said liquid from and purging said at least one contactor.

56. The process of any one of claims 39 to 55, further comprising providing a plurality of said at least one contactor; and performing at least at least one of step (a1), step (b1) and step (c1) concurrently or in parallel in said plurality of said at least one contactor, or performing at least one of step (a1), step (b1) and step (c1) by staggering or alternating step (a1), step (b1) and step (c1) in said plurality of said at least one contactor.

57. The process of any one of claims 39 to 55, wherein said at least one contactor comprises a first contactor, a second contactor and a third contactor fluidly connected in series, said process further comprising:
during at least a fraction of step (a1) in said first contactor,
contacting said feed stream with said first contactor,
recovering said first product stream from said first and
admitting said first product stream from said first contactor as a feed stream into said second contactor; and
during at least a fraction of step (a2) in said second contactor,
contacting said feed stream in said second contactor,
recovering said first product stream from said second contactor and
admitting said first product stream from said second contactor as a feed stream into said third contactor.

58. The process of any one of claims 39 to 55, wherein said at least one contactor comprises a first contactor, and a second contactor fluidly connected in series further comprising, during at least a fraction of step (b1) in said first contactor contacting said first regeneration stream with said first, recovering a first fraction of said second product stream from said first contactor and contacting said first fraction of said second product stream from said first contactor as said first regeneration stream into said second contactor; and during at least a fraction step (b2) contacting said first regeneration stream in said second contactor, recovering a second fraction of said second product stream from said second contactor.

59. The process of claim 58, wherein said at least one contactor further comprise a third contactor fluidly connected in series to said second contactor, the process further comprising step (b3) immediately after step (b2) and during at least a fraction of a third step (b3) contacting said second fraction of said second product stream from said second contactor as a first regeneration stream into said third contactor.

60. The process of claim 56, further comprising during steps (a1) and (b1) fluidly connecting said plurality of said at least one contactor in series, and during at least a portion of step (c1) fluidly connecting said plurality of said at least one contactor in parallel.

61. The process of any one of claims 39 to 55, wherein said at least one contactor further comprise a first contactor, a second contactor, and a third contactor, said process comprising:
a step (b3) immediately after step (b2) comprising performing one of step (b1), step (b2) and a step (b3) in said first contactor, said second contactor, and said third contactor, where step (b1), step (b2) and step (b3) are performed in parallel;
during step (b3) contacting a third regeneration stream with said at least one sorbent in one of said first contactor, said second contactor, and said third contactor; and recovering a third fraction of said second product stream from one of said first contactor, said second contactor, or said third contactor;
during step (b1) using said third fraction of said second product stream recovered in step (b3) as at least a portion of said first regeneration stream, contacting said first regeneration stream with said at least one sorbent in one of said first contactor, said second contactor, and said third contactor, and recovering said first fraction of said second product stream from one of said first contactor, said second contactor, or said third contactor; and
during step (b2) contacting said second regeneration stream with said at least one sorbent in one of said first contactor, said second contactor, and said third contactor, and recovering said second fraction of said second product stream as a purified first component stream,
wherein step (b1), step (b2) and step (b3) are performed sequentially in said first contactor, said second contactor, and said third contactor.

62. The process of claim 39, further comprising during step (a1) passing said first feed stream having a first partial pressure of said first component and during step (a2) passing said second feed stream having a second partial pressure of said first component, wherein said first partial pressure is less than said second partial pressure.

63. The process of claim 62, wherein said first feed stream comprise an air stream, said second feed stream comprise a flue gas stream, said first component is carbon dioxide and said third component is water.

64. The process of claim 62 or 63, wherein said at least one contactor further comprises a first contactor, and a second contactor, said process further comprising:
performing in said first contactor step (a1), step (a2), step (b) or steps (b1) and (b2), step (c) or steps (c1) and (c2); and
performing in said second contactor step (a2), step (b) or steps (b1) and (b2), step (c) or steps (c1) and (c2).

65. The process any one of claims 39 to 64, further comprising a step (b3) immediately after step (b2) comprising:
reducing a pressure in said at least one contactor;
contacting a second regeneration stream or a third regeneration stream along said at least one sorbent;
desorbing said first component and said third component from said at least one sorbent; and
recovering said first component and third component from said at least one contactor.

66. The process of claim 55, wherein during step (b3), said pressure in said at least one contactor is in a range of 0.1 to 0.4 Bara.

67. The process of any one of claims 39 to 66, wherein said first component is carbon dioxide, said second component is nitrogen and said third component is water.

68. The process of any one of claims 39 to 67, further comprising
performing said sorptive gas separation process in equal to or less than 2 minutes and during step (b) said contacting said first regeneration stream along said at least one contactor comprising said at least one sorbent is at a duration equal to or less than 15 seconds, or preferably equal to or less than 10 seconds; preferably performing said sorptive gas separation process in equal to or less than 1 minute and during step (b) said contacting said first regeneration stream along said at least one contactor comprising said at least one sorbent is at a duration equal to or less than 8 seconds; or more preferably performing said sorptive gas separation process in equal to or less than seconds and during step (b) said contacting said first regeneration stream along said at least one contactor comprising said at least one sorbent is at a duration equal to or less than 6 seconds.

69. A cyclic sorptive gas separation process for separating a component of a feed stream comprising at least a first component and a second component, said sorptive gas separation process comprising:
(a) contacting said feed stream along at least one contactor comprising at least one sorbent;
(b) sorbing said first component of said feed stream onto said at least one sorbent;
(c) producing a first product stream partially depleted of said first component relative to said feed stream;
(d) recovering said first product stream from said at least one contactor;
(e) producing a first regeneration stream having a third component within a vessel fluidly connected to said at least one contactor or within said at least one contactor, said first regeneration stream having partial pressure of said third component equal to or greater than a third component partial pressure threshold of 0.4 Bara during at least a fraction of step (b);
(f) contacting said first regeneration stream with said at least one sorbent in said least one contactor;
(g) sorbing or condensing a fraction of said third component of said first regeneration stream onto said at least one sorbent and desorbing a fraction of said first component from said at least one sorbent, and
(h) recovering a second product stream from said at least one contactor.

70. The process of claim 69, wherein said at least one sorbent is one of: a metal organic framework (MOF) sorbent, a polyethylenimine doped silica (PEIDS) sorbent, an amine containing porous network polymer sorbent, an amine doped porous material sorbent, an amine doped MOF sorbent, a zeolite sorbent, an activated carbon, a doped activated carbon, a doped graphene, an alkali-doped or rare earth doped porous inorganic sorbent.

71. The process of claim 69, further comprising during step (b) contacting said first regeneration stream in said at least one contactor at a pressure within said at least one contactor between a pressure threshold range of 0.4 Bara to Bara, wherein said first regeneration stream is in a liquid phase at a temperature equal to or greater than an evaporation temperature of said third component within said at least one contactor during step (b).

72. The process of claim 69, further comprising during step (b), generating a heat of adsorption from sorbing or condensing said fraction of said third component of said first regeneration stream onto said at least one sorbent and transferring at least a portion of said heat of adsorption to said third component in said liquid phase by at least one of thermal conduction and thermal convection.

73. The process of any one of claims 69 to 72, further comprising providing said at least one contactor having a wetted surface of said at least one contactor which repels water in a liquid phase, for preventing liquid water from occupying a pore volume and/or a flow channel of said at least one contactor.

74. The process of any one of claims 69 to 73, further comprising after step (a) and before step (b) flooding or submersing said at least one contactor into a liquid and displacing a gas in one or more flow channels or voids of said at least one contactor, for increasing said fraction of said first component recovered from said at least one contactor or said second product stream during step (b).

75. The process of any one of claims 69 to 74, further comprising before step (b), reducing a pressure in said at least one contactor, flooding or submersing said at least one contactor in a liquid; and after said flooding or said submersing said at least one contactor in said liquid at least one of draining said liquid from and purging said at least one contactor.

76. The process of claim 69, wherein said at least one contactor comprises a first contactor and a second contactor, said process further comprising:
during at least a fraction of step (a) in said first contactor,
contacting said feed stream with said first contactor,
recovering said first product stream from said first contactor and
admitting said first product stream from said first contactor as a feed stream into said second contactor; and
during at least a fraction of step (a) in said second contactor,
contacting said feed stream in said second contactor,
recovering said first product stream from said second contactor and
directing said first product stream from said second contactor as a feed stream.

77. The process of any one of claims 69 to 76, further comprising step (b2) immediately after step (b), comprising:
reducing a pressure in said at least one contactor;
contacting a second regeneration stream along said at least one sorbent;
desorbing said first component and said third component from said at least one sorbent; and
recovering said first component and third component from said at least one contactor.

78. The process of claim 77, wherein during step (b2), said pressure in said at least one contactor is in a range of 0.1 to 0.4 Bara.

79. The process any one of claims 69 to 78, further comprising:
condensing and recycling said third component from at least one of said feed stream, said first product stream, and said third product stream; and
using said third component for at least one of: said first regeneration stream, and said second regeneration stream, and
wherein said third component is water.

80. The process of any one of claims 69 to 78, wherein said first component is carbon dioxide and said third component is water.

81. The process of any one of claims 69 to 80, wherein a pressure of said feed stream is in a range of 1 to 5 Bara.

82. The process of any one of claims 69 to 81, further comprising performing said sorptive gas separation process in equal to or less than 2 minutes and during step (b) said contacting said first regeneration stream along said at least one contactor comprising said at least one sorbent is at a duration equal to or less than 15 seconds, or preferably equal to or less than 10 seconds; preferably performing said sorptive gas separation process in equal to or less than 1 minute and during step (b) said contacting said first regeneration stream along said at least one contactor comprising said at least one sorbent is at a duration equal to or less than 8 seconds; or more preferably performing said sorptive gas separation process in equal to or less than seconds and during step (b) said contacting said first regeneration stream along said at least one contactor comprising said at least one sorbent is at a duration equal to or less than 6 seconds.
